(19) United States
(12) Patent Application Publication
(10) Pub. No.: US 2026/0046058 A1
(43) Pub. Date: Feb. 12, 2026

(54) ELECTRONIC DEVICE FOR PERFORMING RATE ADAPTATION USING DOWNLINK AND UPLINK RETRANSMISSION INDICATORS AND OPERATING METHOD THEREOF

(71) Applicant: SAMSUNG ELECTRONICS CO., LTD., Suwon-si (KR)

(72) Inventors: Janggun BAE, Suwon-si (KR); Yongtae Kim, Suwon-si (KR); Taeyang Park, Suwon-si (KR); Hongju Park, Suwon-si (KR); Jungmin Yoon, Suwon-si (KR); Jisoo Lim, Suwon-si (KR)

(73) Assignee: SAMSUNG ELECTRONICS CO., LTD., Suwon-si (KR)

(21) Appl. No.: 19/265,308

(22) Filed: Jul. 10, 2025

Related U.S. Application Data
(63) Continuation of application No. PCT/KR2025/007058, filed on May 26, 2025.

(30) Foreign Application Priority Data
Aug. 6, 2024 (KR) 10-2024-0104734
Oct. 7, 2024 (KR) 10-2024-0135928

(51) Int. Cl. H04L 1/00; H04L 1/08

(52) U.S. Cl. CPC H04L 1/0002; H04L 1/08

(57) ABSTRACT

An electronic device includes one or more processors comprising processing circuitry, and memory storing instructions. The instructions, when executed by the one or more processors individually or collectively, cause the electronic device to transmit, during a first time interval, a plurality of first uplink data packets encoded by a codec based on a first bit rate, identify a number of first retransmitted uplink data packets, from among the plurality of first uplink data packets, having a first retransmission count greater than or equal to a first retransmission threshold, and adjust a bit rate of the codec from the first bit rate to a second bit rate based on the number of first retransmitted uplink data packets.

### CROSS-REFERENCE TO RELATED APPLICATIONS

This application is a continuation application of International Application No. PCT/KR2025/007058, filed on May 26, 2025, which claims priority to Korean Patent Application No. 10-2024-0104734, filed on Aug. 6, 2024, and Korean Patent Application No. 10-2024-0135928, filed on Oct. 7, 2024, in the Korean Intellectual Property Office, the disclosures of which are incorporated by reference herein in their entireties.

### BACKGROUND

### 1. Field

The present disclosure relates generally to communication devices, and more particularly to an electronic device for performing a rate adaptation using downlink and uplink retransmission indicators and an operating method thereof.

### 2. Description of Related Art

An electronic device may perform uplink communication and/or downlink communication with a network. For example, the electronic device may transmit a packet (e.g., a voice packet) to the network and/or receive a packet (e.g., a voice packet) from the network.

The electronic device may calculate a block error rate (BLER) when performing uplink communication and may perform a rate adaptation based on the BLER. For example, the electronic device may lower a bit rate of a codec when the BLER is calculated to be relatively high while performing uplink communication.

That is, the electronic device may perform the rate adaptation based on a value of the BLER, rather than whether a problem may have occurred in packet transmission. Consequently, whenever the BLER is calculated to be relatively high, even if a packet transmission problem may not have occurred, the electronic device may lower the bit rate of the codec, which may degrade audio quality.

### SUMMARY

One or more example embodiments of the present disclosure provide an electronic device capable of performing a rate adaptation when a problem occurs in packet transmission or packet reception, thereby potentially avoiding unnecessarily degrading audio quality.

According to an aspect of the present disclosure, an electronic device includes one or more processors comprising processing circuitry, and memory storing instructions. The instructions, when executed by the one or more processors individually or collectively, cause the electronic device to transmit, during a first time interval, a plurality of first uplink data packets encoded by a codec based on a first bit rate. The instructions, when executed by the one or more processors individually or collectively, cause the electronic device to identify a number of first retransmitted uplink data packets, from among the plurality of first uplink data packets, having a first retransmission count greater than or equal to a first retransmission threshold. The instructions, when executed by the one or more processors individually or collectively, cause the electronic device to adjust a bit rate of the codec from the first bit rate to a second bit rate based on the number of first retransmitted uplink data packets.

The adjusting of the bit rate may comprise adjusting, based on the number of first retransmitted uplink data packets being greater than or equal to a first count threshold, the bit rate of the codec from the first bit rate to the second bit rate, the second bit rate being lower than the first bit rate.

The adjusting of the bit rate may comprise adjusting, based on the number of first retransmitted uplink data packets being less than a second count threshold, the bit rate of the codec from the first bit rate to the second bit rate, the second bit rate being greater than the first bit rate.

The instructions, when executed by the one or more processors of the electronic device individually or collectively, may further cause the electronic device to determine the first retransmission threshold.

The instructions, when executed by the one or more processors of the electronic device individually or collectively, may further cause the electronic device to receive, from a base station, a maximum retransmission threshold. The first retransmission threshold may correspond to the maximum retransmission threshold.

The identifying of the number of the first retransmitted uplink data packets may comprise identifying whether a second retransmission count of at least one uplink data packet of the plurality of first uplink data packets reaches the maximum retransmission threshold. The adjusting of the bit rate may comprise adjusting the bit rate of the codec from the first bit rate to a lower bit rate than the first bit rate based on the second retransmission count of the at least one uplink data packet reaching the maximum retransmission threshold.

The instructions, when executed by the one or more processors of the electronic device individually or collectively, may further cause the electronic device to determine an uplink retransmission indicator based on retransmission counts of the first retransmitted uplink data packets, determine whether to adjust the bit rate of the codec based on the uplink retransmission indicator, and adjust the first bit rate based on a determination to adjust the bit rate of the codec.

The determining of the uplink retransmission indicator may comprise calculating a first ratio between a number of the plurality of first uplink data packets and the number of first retransmitted uplink data packets. The determining whether to adjust the bit rate may comprise determining whether each of the calculated first ratio and a ratio between a number of second uplink data packets during a previous time interval of the first time interval and a number of second retransmitted uplink data packets during the previous time interval is greater than or equal to a first threshold value, wherein the second retransmitted uplink data packets are associated with a second retransmission count that is greater than or equal to the first retransmission threshold among the second uplink data packets. Alternatively, the determining whether to adjust the bit rate may comprise determining whether each of the calculated first ratio and the ratio is less than a second threshold value.

The adjusting of the first bit rate may comprise adjusting the bit rate of the codec from the first bit rate to a third bit rate based on the calculated first ratio and the ratio being greater than or equal to the first threshold value, the third bit rate being less than the first bit rate. The adjusting of the first bit rate may comprise adjusting the bit rate of the codec from the first bit rate to a fourth bit rate based on the calculated first ratio and the ratio being less than the second threshold value, the fourth bit rate being greater than the first bit rate.

The determining of the uplink retransmission indicator may comprise calculating a second ratio between a number of uplink data packets having a retransmission count that reaches a maximum retransmission threshold and a number of the plurality of first uplink data packets. The determining whether to adjust the bit rate may comprise determine whether to adjust the bit rate of the codec based on the second ratio.

The adjusting of the first bit rate may comprise adjusting the bit rate of the codec from the first bit rate to a lower bit rate than the first bit rate based on the second ratio being greater than or equal to a third threshold value. The adjusting of the first bit rate may comprise adjusting the bit rate of the codec from the first bit rate to a greater bit rate than the first bit rate based on the second ratio being less than or equal to a fourth threshold value.

The instructions, when executed by the one or more processors of the electronic device individually or collectively, may further cause the electronic device to receive, during the first time interval, a plurality of first downlink data packets, identify, from among the plurality of first downlink data packets, first retransmitted downlink data packets that have been retransmitted during the first time interval, determine a downlink retransmission indicator based on retransmission counts of the first retransmitted downlink data packets, and determine whether to adjust the bit rate of the codec based on the downlink retransmission indicator.

The determining of the downlink retransmission indicator may comprise calculating a third ratio between a number of the first downlink data packets and a number of the first retransmitted downlink data packets. The determining whether to adjust the bit rate may comprise determining whether each of the calculated third ratio and a ratio between a number of second retransmitted downlink data packets retransmitted from among downlink data packets during a previous time interval of the first time interval and a number of the downlink data packets during the previous time interval is greater than or equal to a fifth threshold value. Alternatively, the determining whether to adjust the bit rate may comprise determining whether each of the calculated third ratio and the ratio is less than a sixth threshold value. Alternatively, the determining whether to adjust the bit rate may comprise determining whether the calculated third ratio is less than or equal to a seventh threshold value.

The adjusting of the first bit rate may comprise adjusting the bit rate of the codec from the first bit rate to a lower bit rate than the first bit rate based on the ratio and the calculated third ratio being greater than or equal to the fifth threshold value. The adjusting of the first bit rate may comprise adjusting the bit rate of the codec from the first bit rate to a greater bit rate than the first bit rate based on the ratio and the calculated third ratio being less than the sixth threshold value. The adjusting of the first bit rate may comprise adjusting the bit rate of the codec from the first bit rate to a greater bit rate than the first bit rate based on the calculated third ratio being less than or equal to the seventh threshold value.

According to an aspect of the present disclosure, an electronic device includes one or more processors comprising processing circuitry, and memory storing instructions. The instructions, when executed by the one or more processors individually or collectively, cause the electronic device to transmit, during a first time interval, a plurality of first uplink data packets. The instructions, when executed by the one or more processors individually or collectively, cause the electronic device to identify, from among the plurality of first uplink data packets, first retransmitted uplink data packets having a first retransmission count greater than or equal to a first retransmission threshold. The instructions, when executed by the one or more processors individually or collectively, cause the electronic device to determine an uplink retransmission indicator based on retransmission counts of the first retransmitted uplink data packets. The instructions, when executed by the one or more processors individually or collectively, cause the electronic device to determine whether to adjust a bit rate of a codec based on the retransmission indicator. The instructions, when executed by the one or more processors individually or collectively, cause the electronic device to adjust the bit rate of the codec based on a determination to adjust the bit rate of the codec.

The determining of the uplink retransmission indicator may comprise calculating a first ratio between a number of the first uplink data packets and a number of the first retransmitted uplink data packets. The determining whether to adjust the bit rate comprises determining whether each of the calculated first ratio and a ratio between a number of second uplink data packets during a previous time interval of the first time interval and a number of second retransmitted uplink data packets during the previous time interval is greater than or equal to a first threshold value, wherein the second retransmitted uplink data packets are associated with a second retransmission count that is greater than or equal to the first retransmission threshold among the second uplink data packets. Alternatively, The determining whether to adjust the bit rate may comprise determining whether each of the calculated first ratio and the ratio is less than a second threshold value.

The adjusting of the bit rate may comprise lowering the bit rate of the codec based on the calculated first ratio and the ratio being greater than or equal to the first threshold value. The adjusting of the bit rate may comprise increasing the bit rate of the codec based on the calculated first ratio and the ratio being less than the second threshold value.

The determining of the uplink retransmission indicator may comprise calculating a second ratio between a number of uplink data packets of which retransmission count reaches a maximum retransmission threshold and a number of the first uplink data packets. The determining whether to adjust the bit rate may comprise determining whether the calculated second ratio is greater than or equal to a third threshold value or less than or equal to a fourth threshold value.

The adjusting of the bit rate may comprise lowering the bit rate of the codec based on the second ratio being greater than or equal to the third threshold value. The adjusting of the bit rate may comprise increasing the bit rate of the codec based the second ratio being less than or equal to the fourth threshold value.

According to an aspect of the present disclosure, an operating method of an electronic device includes transmitting, during a time interval, a plurality of uplink data packets, the plurality of uplink data packets being generated by a codec based on a first bit rate. The operating method includes identifying a number of retransmitted uplink data packets, from among the plurality of uplink data packets, having a retransmission count greater than or equal to a retransmission threshold. The operating method includes adjusting a bit rate of the codec from the first bit rate to a second bit rate based on the number of the retransmitted uplink data packets.

According to an aspect of the present disclosure, a non-transitory computer-readable storage medium stores computer-executable instructions. The computer-executable instructions, when executed by one or more processors individually or collectively, cause the electronic device to transmit, during a first time interval, a plurality of first uplink data packets encoded by a codec based on a first bit rate, identify a number of first retransmitted uplink data packets, from among the plurality of first uplink data packets, having a first retransmission count greater than or equal to a first retransmission threshold, and adjust a bit rate of the codec from the first bit rate to a second bit rate based on the number of first retransmitted uplink data packets.

According to an aspect of the present disclosure, a non-transitory computer-readable storage medium stores computer-executable instructions. The computer-executable instructions, when executed by one or more processors individually or collectively, cause the electronic device to transmit, during a first time interval, a plurality of first uplink data packets, identify, from among the plurality of first uplink data packets, first retransmitted uplink data packets having a first retransmission count greater than or equal to a first retransmission threshold, determine an uplink retransmission indicator based on retransmission counts of the first retransmitted uplink data packets, determine whether to adjust a bit rate of a codec based on the retransmission indicator, and adjust the bit rate of the codec based on a determination to adjust the bit rate of the codec.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description, taken in conjunction with the accompanying drawings, in which:

FIG. 1 is a block diagram illustrating an electronic device in a network environment, according to an embodiment;

FIG. 2 is a block diagram illustrating an electronic device in a network environment including a plurality of cellular networks, according to an embodiment;

FIGS. 3A and 3B are diagrams illustrating an example of a method of determining a downlink retransmission indicator, according to an embodiment;

FIGS. 4A and 4B are diagrams illustrating an example of a method of determining an uplink retransmission indicator, according to an embodiment;

FIGS. 5 and 6 are diagrams illustrating an example of an operating method of an electronic device, according to an embodiment;

FIGS. 7 and 8 are diagrams illustrating an example of an operating method of an electronic device, according to an embodiment;

FIG. 9 is a diagram illustrating an example of an operation in which an electronic device adjusts a bit rate based on an uplink retransmission indicator, according to an embodiment;

FIG. 10 is a diagram illustrating an example of an operation in which an electronic device adjusts a bit rate based on a downlink retransmission indicator, according to an embodiment;

FIG. 11 is a block diagram illustrating an example of a configuration of an electronic device, according to an embodiment;

FIG. 12 is a flowchart illustrating an example of an operating method of an electronic device, according to an embodiment; and

FIG. 13 is a flowchart illustrating an example of an operating method of an electronic device, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). For example, the terms “first”, “second”, “third”, and the like may not necessarily involve an order or a numerical meaning of any form. It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout the present disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

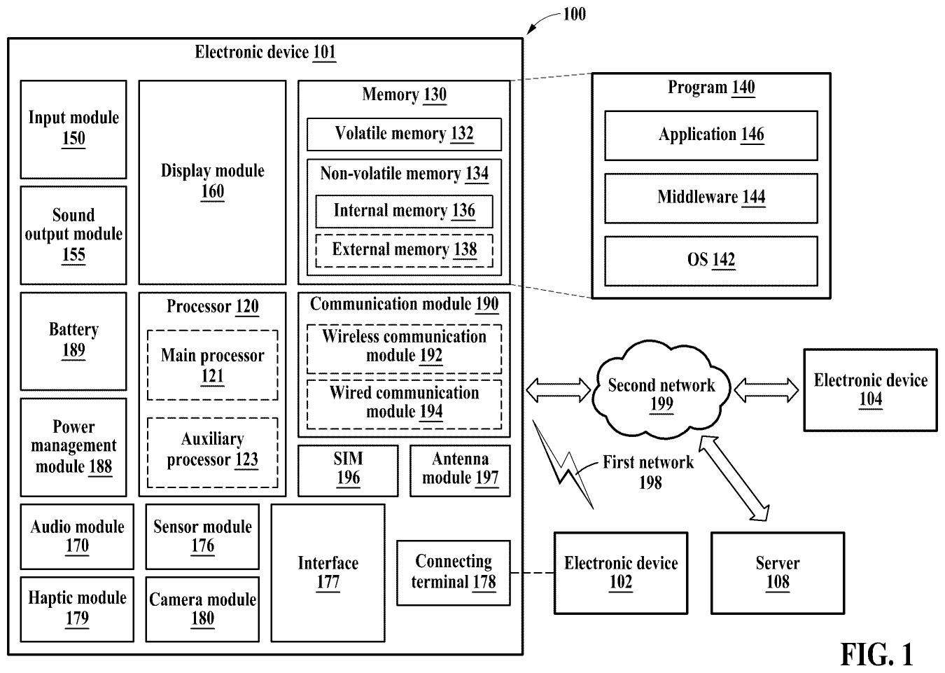

FIG. 1 is a block diagram illustrating an electronic device 101 in a network environment 100, according to an embodiment. Referring to FIG. 1, the electronic device 101 in the network environment 100 may communicate with an electronic device 102 via a first network 198 (e.g., a short-range wireless communication network), or communicate with at least one of an electronic device 104 and a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added to the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specifically for artificial intelligence model processing. The AI model may be generated by machine learning. The machine learning may be performed by, for example, the electronic device 101, in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a record. The receiver may be used to receive an incoming call. According to an embodiment, the receiver may be implemented separately from the speaker or as a portion of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to an embodiment, the display module 160 may include a touch sensor adapted to sense a touch, or a pressure sensor adapted to measure an intensity of a force incurred by the touch. The display module 160 may be implemented with, for example, a foldable structure and/or a rollable structure. For example, a size of a display screen of the display module 160 may be reduced when folded and expanded when unfolded.

The audio module 170 may convert a sound into an electric signal and vice versa. According to an embodiment, the audio module 170 may obtain the sound via the input module 150 or output the sound via the sound output module 155 or an external electronic device (e.g., an electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a portion of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., a LAN or a wide region network (WAN)). These various types of communication modules may be implemented as a single component (e.g., a single chip), or may be implemented as multiple components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed by the electronic device 101 may be executed at one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least portion of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To this end, cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if a component (e.g., a first component) is referred to, with or without the term “operatively” or “communicatively”, as “coupled with,” “coupled to,” “connected with,” or “connected to” another component (e.g., a second component), the component may be coupled with the other component directly (e.g., by wire), wirelessly, or via a third component.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., an internal memory 136 or an external memory 138) that is readable by a machine (e.g., the electronic device 101 of FIG. 1). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

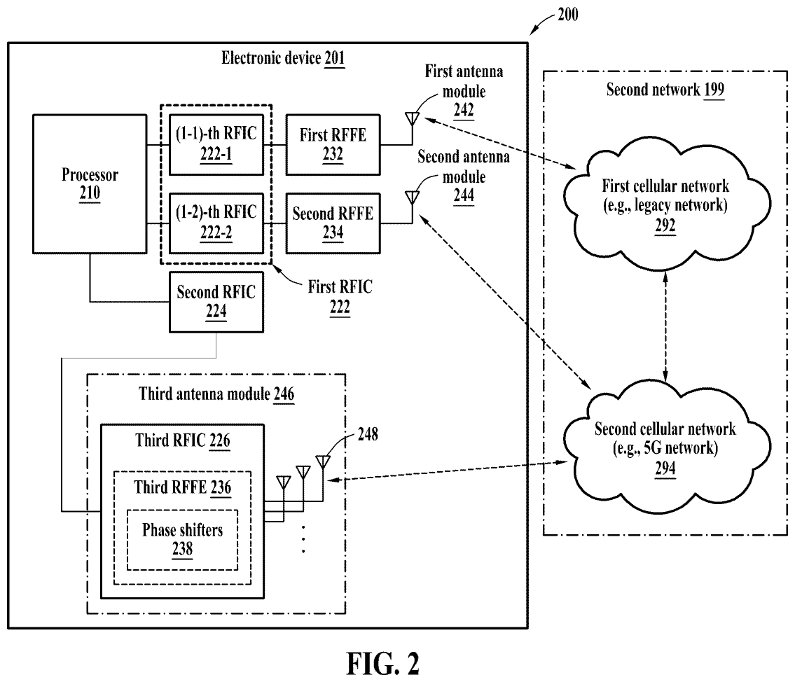

FIG. 2 is a block diagram illustrating an electronic device 201 in a network environment 200 including a plurality of cellular networks, according to an embodiment.

Referring to FIG. 2, the electronic device 201 may include and/or may be similar in many respects to the electronic device 101 described above with reference to FIG. 1, and may include additional features not mentioned above. Consequently, repeated descriptions of the electronic device 201 described above with reference to FIG. 1 may be omitted for the sake of brevity.

As shown in FIG. 2, the electronic device 201 may include a processor 210 (e.g., the processor 120 of FIG. 1 or a CP), a (1-1)-th radio frequency integrated circuit (RFIC) 222-1, a (1-2)-th RFIC 222-2, a second RFIC 224, a first radio frequency front end (RFFE) 232, a second RFFE 234, a first antenna module 242, a second antenna module 244, and a third antenna module 246. Depending on embodiments, the (1-1)-th RFIC 222-1 and the (1-2)-th RFIC 222-2 may be implemented as one RFIC 222. The second network 199 may include a first cellular network 292 (e.g., a legacy network) and a second cellular network 294 (e.g., a 5G network). The electronic device 201 may further include at least one of the components described with reference to FIG. 1, and the second network 199 may further include at least one another network. According to an embodiment, the second RFIC 224 may be omitted or included as a portion of a third RFIC 226.

According to an embodiment, the (1-1)-th RFIC 222-1, the (1-2)-th RFIC 222-2, the second RFIC 224, the first RFFE 232, and the second RFFE 234 of FIG. 2 may be included in the communication module 190 (e.g., the wireless communication module 192) of FIG. 1, and the first antenna module 242, the second antenna module 244, and the third antenna module 246 of FIG. 2 may be included in the antenna module 197 of FIG. 1.

According to an embodiment, the processor 210 may establish a communication channel of a band to be used for wireless communication with the first cellular network 292 and support legacy network communication through the established communication channel. The first cellular network 292 may be and/or may include, for example, a legacy network including a second generation (2G) network, a third generation (3G) network, a 4G network, or long-term evolution (LTE) network. The processor 210 may establish a communication channel corresponding to a first band (e.g., about 6 gigahertz (GHz) to about 60 GHz) ((or a 5G standard frequency range (FR) 2 (e.g., 24.25 GHz to 52.6 GHz)) among bands to be used for wireless communication with the second cellular network 294 and may support 5G network communication through the established communication channel. The second cellular network 294 may be a 5G network defined by a third generation partnership project (3GPP). The processor 210 may establish a communication channel corresponding to a second band (e.g., about 6 GHz or less) ((or a 5G standard FR1 (e.g., 410 megahertz (MHz) to 7.125 GHz)) among bands to be used for wireless communication with the second cellular network 294 and may support 5G network communication through the established communication channel.

According to an embodiment, during transmission, the (1-1)-th RFIC 222-1 (or the first RFIC 222) may convert a baseband signal generated by the processor 210 into a radio frequency (RF) signal of a frequency band (e.g., about 700 megahertz (MHz) to about 3 GHz) to be used in the first cellular network 292. During reception, an RF signal may be received and/or acquired from the first cellular network 292 via the first antenna module 242 and may be preprocessed through the first RFFE 232. The (1-1)-th RFIC 222-1 (or the first RFIC 222) may convert the preprocessed RF signal into a baseband signal such that the signal may be processed by the processor 210.

According to an embodiment, during transmission, the (1-2)-th RFIC 222-2 (or the first RFIC 222) may convert a baseband signal generated by the processor 210 into an RF signal (hereinafter, referred to as a “5G Sub6 RF signal”) of a Sub6 band (e.g., about 6 GHz or less) to be used in the second cellular network 294. During reception, the 5G Sub6 RF signal may be received or acquired from the second cellular network 294 via the second antenna module 244 and may be preprocessed through the second RFFE 234. The (1-2)-th RFIC 222-2 (or the first RFIC 222) may convert the preprocessed 5G Sub6 RF signal into a baseband signal such that the signal may be processed by the processor 210.

According to an embodiment, the third RFIC 226 may convert a baseband signal generated by the processor 210 into an RF signal (hereinafter, referred to as a “5G Above6 RF signal”) of a 5G Above6 band (e.g., about 6 GHz to about 60 GHz) to be used in the second cellular network 294. During reception, the 5G Above6 RF signal may be received or acquired from the second cellular network 294 via the third antenna module 246 (e.g., an antenna 248) and may be preprocessed through a third RFFE 236. The third RFIC 226 may convert the preprocessed 5G Above6 RF signal into a baseband signal such that the signal may be processed by the processor 210. According to an embodiment, the third RFFE 236 may be formed as a portion of the third RFIC 226.

According to an embodiment, the electronic device 201 may include the second RFIC 224 separately from the third RFIC 226 or as at least a portion of the third RFIC 226. In such a case, the second RFIC 224 may convert a baseband signal generated by the processor 210 into an RF signal (hereinafter, referred to as an intermediate frequency (IF) signal) of an intermediate frequency band (e.g., about 9 GHz to 11 GHz) and may transmit the IF signal to the third RFIC 226. The third RFIC 226 may convert the IF signal into a 5G Above6 RF signal. During reception, the 5G Above6 RF signal may be received or acquired from the second cellular network 294 via the third antenna module 246 (e.g., the antenna 248) and may be converted into an IF signal by the third RFIC 226. The second RFIC 224 may convert the IF signal into a baseband signal such that the signal may be processed by the processor 210.

According to an embodiment, at least one of the first antenna module 242 or the second antenna module 244 may be omitted or combined with another antenna module to process RF signals of a plurality of corresponding bands.

According to an embodiment, the third RFIC 226 and the antenna 248 may be disposed on the same substrate to form the third antenna module 246. For example, the processor 120 may be disposed on a first substrate (e.g., a main PCB). In such a case, the third RFIC 226 may be disposed on a partial area (e.g., a bottom surface) of a second substrate (e.g., a sub PCB) that may be separate from the first substrate, and the antenna 248 may be disposed on another partial area (e.g., a top surface) of the second substrate (e.g., the sub PCB), to form the third antenna module 246. The third RFIC 226 and the antenna 248 may be disposed on the same substrate, and accordingly, it may be possible to reduce a length of a transmission line between the third RFIC 226 and the antenna 248. For example, a loss (e.g., attenuation) of a signal in the high-frequency band (e.g., about 6 GHz to about 60 GHz) used for 5G network communication by the transmission line may be reduced. Thus, the electronic device 201 may enhance the quality and/or speed of communication with the second cellular network 294 (e.g., a 5G network).

According to an embodiment, the antenna 248 may be formed as an antenna array including a plurality of antenna elements that may be used for beamforming. In such a case, the third RFIC 226 may include, for example, a plurality of phase shifters 238 corresponding to the plurality of antenna elements as a portion of the third RFFE 236. During transmission, each of the plurality of phase shifters 238 may convert a phase of a 5G Above6 RF signal to be transmitted to the outside (e.g., a base station of a 5G network) of the electronic device 201 through a corresponding antenna element. During reception, each of the plurality of phase shifters 238 may convert a phase of a 5G Above6 RF signal received from the outside (e.g., the base station of the 5G network) through the corresponding antenna element into the same or substantially the same phase. Thus, transmission and/or reception through beamforming between the electronic device 201 and the outside may be enabled.

The second cellular network 294 may be operated independently of the first cellular network 292 (e.g., standalone (SA)) or in connection to the first cellular network 292 (e.g., non-standalone (NSA)). For example, a 5G network may include only an access network (e.g., a 5G radio access network (RAN) or a next generation RAN (NG RAN)) and may not include a core network (e.g., a next generation core (NGC)). In such a case, after accessing an access network of the 5G network, the electronic device 201 may access an external network (e.g., the Internet) under a control of a core network (e.g., an evolved packet core (EPC)) of a legacy network. Protocol information (e.g., LTE protocol information) for communication with a legacy network or protocol information (e.g., NR protocol information) for communication with the 5G network may be stored in memory (e.g., the memory 130) to be accessed by the processor 210.

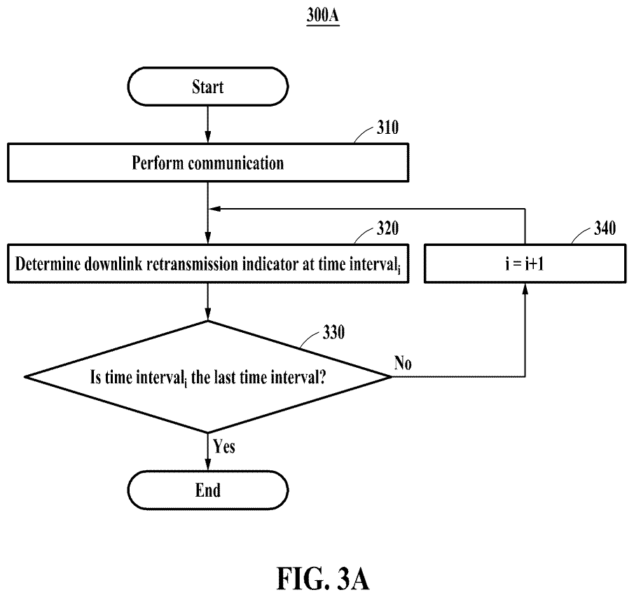

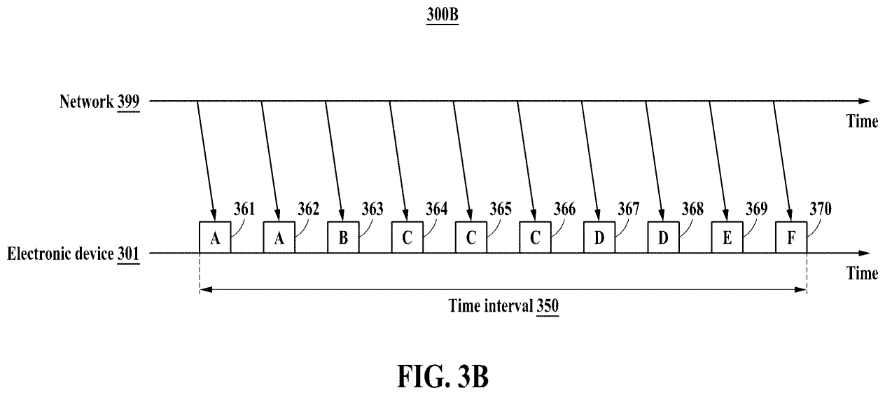

FIGS. 3A and 3B are diagrams illustrating an example of a method of determining a downlink retransmission indicator, according to an embodiment.

Referring to FIG. 3A, a method 300A of determining a downlink retransmission indicator may include, in operation 310, an electronic device (e.g., the electronic device 101 of FIG. 1, the electronic device 201 of FIG. 2), according to an embodiment, may perform communication. For example, the electronic device may perform a call according to voice over LTE (VOLTE) and/or a call according to voice over NR (VoNR). However, the present disclosure is not limited in this regard. The electronic device may transmit a voice packet (and/or voice data) to a network (e.g., the second network 199 of FIGS. 1 and 2) and/or receive a voice packet (or voice data) from the network. As another example, the electronic device may transmit and/or receive an image packet (or image data) to and/or from the network. As another example, the electronic device may transmit and/or receive data regarding the play of an online game to and/or from the network.

In operation 320, the electronic device may determine (or calculate) a downlink retransmission (ReTX) indicator at a time interval i while performing communication. The downlink retransmission indicator may indicate, for example, an indicator regarding the retransmission of downlink data.

According to an embodiment, the downlink retransmission indicator in the time interval i may include, for example, an indicator regarding an electronic device receiving data retransmitted by the network (and/or the electronic device receiving the same data redundantly from the network) (hereinafter, referred to as “downlink retransmission”). The downlink retransmission indicator in the time interval i may include, for example, the number of pieces of retransmission data received by the electronic device in the time interval i (or the number of pieces of data received redundantly by the electronic device in the time interval i) (hereinafter, referred to as a “downlink retransmission number (or a first DL ReTX indicator)”). The downlink retransmission indicator in the time interval i may include, for example, a ratio (hereinafter, referred to as a “downlink retransmission ratio (or a second DL ReTX indicator)”) between the number of pieces of data received in the time interval i and the downlink retransmission number in the time interval i. The downlink retransmission indicator is described with reference to FIG. 3B.

In operation 330, the electronic device may determine whether the time interval i is the last time interval of communication.

When the time interval i is not the last time interval of communication (No at operation 330), in operation 340, the electronic device may update an index i of the time interval i to i+1, and in operation 320, the electronic device may determine the downlink retransmission indicator in the time interval i+1. The electronic device may determine a downlink retransmission indicator in the next time interval (e.g., time interval i+1) when the time interval i is not the last time interval of communication (No at operation 330).

When the time interval i is the last time interval of communication (Yes at operation 330), the method 300A may terminate.

In the example process 300B, as illustrated in FIG. 3B, the electronic device 301 may receive data (or downlink data) (e.g., one or more packets) from a network 399 (or base station) in a time interval 350. The electronic device 301 may include and/or may be similar in many respects to the electronic device 101 or the electronic device 201 described above with reference to FIGS. 1 and 2, and may include additional features not mentioned above. Consequently, repeated descriptions of the electronic device 301 described above with reference to FIGS. 1 and 2 may be omitted for the sake of brevity.

The electronic device 301 may receive data A 361 (e.g., voice packet A) from the network 399 and transmit, to the network 399, acknowledgment (ACK) (e.g., hybrid automatic repeat and request (HARQ) ACK)) for the data A 361. In an embodiment, the uplink environment between the network 399 and the electronic device 301 may not be appropriate for supporting the communication, and consequently, for example, the network 399 may not receive the ACK for the data A 361 from the electronic device 301. When the ACK for the data A 361 is not received from the electronic device 301, the network 399 may transmit, to the electronic device 301, data A 362 that may be substantially similar and/or the same as to the data A 361.

The electronic device 301 may receive the data A 362 from the network 399. The data A 362 may be substantially similar and/or the same as to the data A 361, so the data A 362 may correspond to retransmission data. The electronic device 301 may discard the data A 362 because the data A 362 may be substantially similar and/or the same as to the data A 361. The electronic device 301 may transmit ACK for the data A 362 to the network 399. When the ACK for the data A 362 is received from the electronic device 301, the network 399 may transmit data B 363 (e.g., voice packet B) to the electronic device 301.

The electronic device 301 may receive the data B 363 from the network 399 and transmit ACK for the data B 363 to the network 399. When the ACK for the data B 363 is received from the electronic device 301, the network 399 may transmit data C 364 (e.g., voice packet C) to the electronic device 301.

The electronic device 301 may receive the data C 364 from the network 399 and transmit ACK for the data C 364 to the network 399. The network 399 may not receive the ACK for the data C 364 from the electronic device 301 and may transmit, to the electronic device 301, data C 365 that may be substantially similar and/or the same as to the data C 364. The electronic device 301 may receive the data C 365 from the network 399. The data C 365 may be substantially similar and/or the same as to the data C 364 that may have already been received, so the data C 365 may correspond to retransmission data. The electronic device 301 may discard the data C 365 and transmit ACK for the data C 365 to the network 399. The network 399 may not receive the ACK for the data C 365 and may transmit, to the electronic device 301, data C 366 that may be substantially similar and/or the same as to the data C 364. The electronic device 301 may receive the data C 366 from the network 399. The data C 366 may be may be substantially similar and/or the same as to the data C 364 that has already been received, so the data C 366 may correspond to retransmission data. The electronic device 301 may discard the data C 366 and transmit ACK for the data C 366 to the network 399. When the ACK for the data C 366 is received from the electronic device 301, the network 399 may transmit data D 367 (e.g., voice packet D) to the electronic device 301.

The electronic device 301 may receive the data D 367 from the network 399 and transmit ACK for the data D 367 to the network 399. The network 399 may not receive the ACK for the data D 367 from the electronic device 301 and may transmit, to the electronic device 301, data D 368 that may be substantially similar and/or the same as to the data D 367. The electronic device 301 may receive the data D 368 from the network 399. The data D 368 may be substantially similar and/or the same as to the data D 367 that has already been received, so the data D 368 may correspond to retransmission data. The electronic device 301 may discard the data D 368. The electronic device 301 may transmit ACK for the data D 368 to the network 399. When the ACK for the data D 368 is received, the network 399 may transmit data E 369 (e.g., voice packet E) to the electronic device 301.

The electronic device 301 may receive the data E 369 from the network 399 and transmit ACK for the data E 369 to the network 399. When the ACK for the data E 369 is received from the electronic device 301, the network 399 may transmit data F 370 (e.g., voice packet F) to the electronic device 301. The electronic device 301 may receive the data F 370 from the network 399.

According to an embodiment, as shown in FIG. 3B, the electronic device 301 may receive a total of ten (10) pieces of data (e.g., the data A 361, the data A 362, the data B 363, the data C 364, the data C 365, the data C 366, the data D 367, the data D 368, the data E 369, and the data F 370) during the time interval 350. The electronic device 301 may discard the pieces of data (e.g., the data A 362, the data C 365, the data C 366, and the data D 368) retransmitted (and/or redundantly received) from among the total of ten (10) pieces of data (e.g., the data A 361, the data A 362, the data B 363, the data C 364, the data C 365, the data C 366, the data D 367, the data D 368, the data E 369, and the data F 370). The pieces of discarded data (e.g., the data A 362, the data C 365, the data C 366, and the data D 368) may correspond to downlink retransmission. The pieces of data that are not discarded (e.g., the data A 361, the data B 363, the data C 364, the data D 367, the data E 369, and the data F 370) may not correspond to downlink retransmission.

According to an embodiment, in the time interval 350, each of the data A 362, the data C 365, the data C 366, and the data D 368 may correspond to retransmission data, so the electronic device 301 may determine (or identify) the downlink retransmission number (e.g., the number of pieces of retransmission data received by the electronic device 301 in the time interval 350) to be four (4). In the time interval 350, the electronic device 301 may determine (or calculate) a downlink retransmission ratio (e.g., a ratio between the number of pieces of data received in the time interval 350 and the downlink retransmission number) to be 0.4 (e.g., 4/10=0.4). The electronic device 301 may receive data (e.g., at least one voice packet) in the next time interval of the time interval 350 and determine (or calculate) a downlink retransmission indicator in the next time interval.

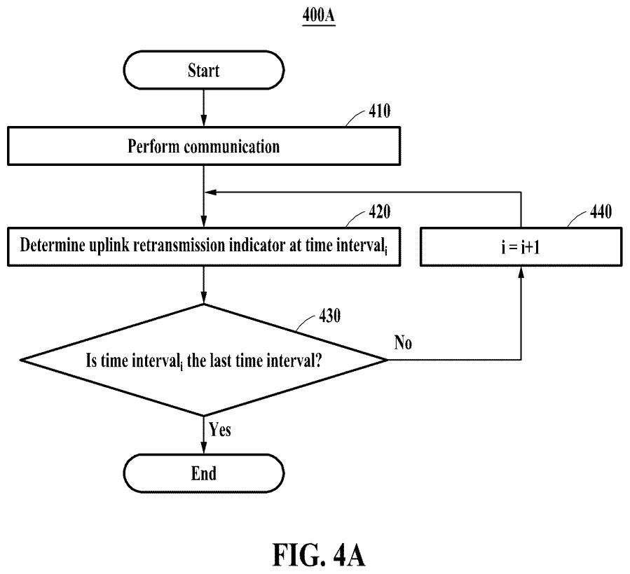

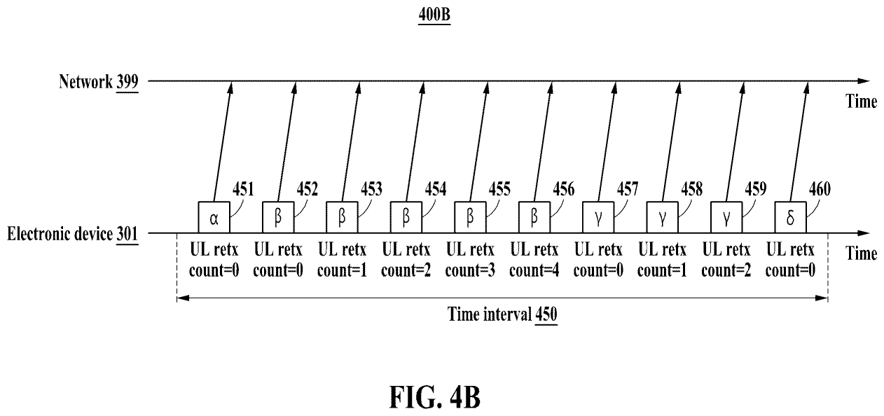

FIGS. 4A and 4B are diagrams illustrating an example of a method of determining an uplink retransmission indicator, according to an embodiment.

Referring to FIG. 4A, a method 400A of determining an uplink retransmission indicator may include, in operation 410 (e.g., similar to operation 310), the electronic device 301 may perform communication. For example, the electronic device 301 may perform a call according to VOLTE and/or a call according to VoNR. As another example, the electronic device 301 may transmit and/or receive an image packet (or image data) to and/or from a network. As another example, the electronic device 301 may transmit and/or receive data regarding the play of an online game to and/or from the network.

In operation 420, the electronic device 301 may determine (or calculate) an uplink retransmission indicator in a time interval i while performing communication. The uplink retransmission indicator may indicate, for example, an indicator regarding the retransmission of uplink data.

According to an embodiment, the uplink retransmission indicator in the time interval i may indicate, for example, an indicator regarding the retransmission of uplink data (hereinafter, referred to as “uplink retransmission (UL ReTX)”) of the electronic device 301 in the time interval i. The uplink retransmission indicator in the time interval i may include, for example, a ratio (or number) (hereinafter, referred to as a “first UL ReTX indicator in the time interval i”) of pieces of data of which an uplink retransmission count is greater than or equal to a first count in the time interval i and/or a ratio (or number) (hereinafter, referred to as a “second UL ReTX indicator in the time interval i”) of pieces of data of which an uplink retransmission count reaches the maximum count in the time interval i. The first count may be determined, for example, by the electronic device 301. The first count may be preset, for example. The maximum count may correspond to, for example, maxHARQ-Tx as described by an LTE communications standard (or 5G communications standard). The uplink retransmission count may correspond to an indicator indicating, for example, in which order the data is retransmitted. The uplink retransmission indicator is described below with reference to FIG. 4B. The first count may be referred to as a first retransmission threshold, and the maximum count may be referred to as a maximum retransmission threshold.

In operation 430, the electronic device 301 may determine whether the time interval i is the last time interval of communication.

When the time interval i is not the last time interval of communication (No at operation 430), in operation 440, the electronic device 301 may update an index i of the time interval i to i+1, and in operation 420, the electronic device 301 may determine an uplink retransmission indicator in the time interval i+1. The electronic device 301 may determine an uplink retransmission indicator in the next time interval (time interval i+1) when the time interval i is not the last time interval of communication (No at operation 430).

The method 400A may terminate when the time interval i is the last time interval of communication (Yes at operation 430).

In the example process 400B, as illustrated in FIG. 4B, the electronic device 301 may transmit data (or uplink data) (e.g., one or more packets) to the network 399 (or base station) in a time interval 450.

The electronic device 301 may transmit data a 451 (e.g., voice packet α) to the network 399. Since the data α 451 may not be data to be retransmitted, the electronic device 301 may set an uplink retransmission count (UL ReTX count) of the data α 451 to zero (0). The electronic device 301 may receive ACK (e.g., HARQ ACK) for the data α 451 from the network 399. The electronic device 301 may transmit data β 452 (e.g., voice packet β) to the network 399 when the ACK for the data α 451 is received from the network 399. Since the data β 452 may not be data to be retransmitted, the electronic device 301 may set an uplink retransmission count of the data β 452 to zero (0).

According to an embodiment, the electronic device 301 may receive negative ACK (NAK) (or not receive ACK) from the network 399 after transmitting the data β 452. The electronic device 301 may transmit, to the network 399, data β 453 that may be substantially similar and/or the same as to the data β 452 when NAK is received (or ACK is not received). The data β 453 may correspond to data to be retransmitted first, so the electronic device 301 may set an uplink retransmission count of the data β 453 to one (1). The electronic device 301 may receive NAK (or not receive ACK) from the network 399 after transmitting the data β 453 and may transmit, to the network 399, data β 454 that may be substantially similar and/or the same as to the data β 452. The data β 454 may correspond to data to be retransmitted second, so the electronic device 301 may set an uplink retransmission count of the data β 454 to two (2). The electronic device 301 may receive NAK (or not receive ACK) from the network 399 after transmitting the data β 454 and may transmit, to the network 399, data β 455 that may be substantially similar and/or the same as to the data β 452. The data β 455 may correspond to data to be retransmitted third, so the electronic device 301 may set an uplink retransmission count of the data β 455 to three (3). The electronic device 301 may receive NAK (or not receive ACK) from the network 399 after transmitting the data β 455 and may transmit, to the network 399, data β 456 that may be substantially similar and/or the same as to the data β 452. The data β 456 may correspond to data to be retransmitted fourth, so the electronic device 301 may set an uplink retransmission count of the data β 456 to four (4).

The electronic device 301 may receive ACK from the network 399 after transmitting the data β 456 and may transmit data γ 457 to the network 399. The data γ 457 may not be data to be retransmitted, so the electronic device 301 may set an uplink retransmission count of the data γ 457 to zero (0). The electronic device 301 may receive NAK (or not receive ACK) from the network 399 after transmitting the data γ 457 and may transmit, to the network 399, data γ 458 that may be substantially similar and/or the same as to the data γ 457. The data γ 458 may correspond to data to be retransmitted, so the electronic device 301 may set an uplink retransmission count of the data γ 458 to one (1). The electronic device 301 may receive NAK (or not receive ACK) from the network 399 after transmitting the data γ 458 and may transmit, to the network 399, data γ 459 that may be substantially similar and/or the same as to the data γ 457. The data γ 459 may correspond to data to be retransmitted second, so the electronic device 301 may set an uplink retransmission count of the data γ 459 to two (2).

The electronic device 301 may receive ACK from the network 399 after transmitting the data γ 459 and may transmit data δ 460 to the network 399. The data δ 460 may not be data to be retransmitted, so the electronic device 301 may set an uplink retransmission count of the data δ 460 to zero (0).

According to an embodiment, the electronic device 301 may determine (or calculate) the uplink retransmission indicator (e.g., a first UL ReTX indicator and/or a second UL ReTX indicator) in the time interval 450.

In the example illustrated in FIG. 4B, the first count may be, for example, three (3). The electronic device 301 may identify that the uplink retransmission count of the data β 455 is three (3) and the uplink retransmission count of the data β 456 is four (4) among the pieces of data (e.g., the data α 451, the data β 452, the data β 453, the data β 454, the data β 455, the data β 456, the data γ 457, the data γ 458, the data γ 459, and the data δ 460) transmitted in the time interval 450. The electronic device 301 may determine (or identify) the number of pieces of data of which an uplink retransmission count is greater than or equal to the first count (e.g., three (3)) to be two (2) among the pieces of data (e.g., the data α 451, the data β 452, the data β 453, the data β 454, the data β 455, the data β 456, the data γ 457, the data γ 458, the data γ 459, and the data δ 460) transmitted in the time interval 450. Since the ten (10) pieces of data (e.g., the data α 451, the data β 452, the data β 453, the data β 454, the data β 455, the data β 456, the data γ 457, the data γ 458, the data γ 459, and the data δ 460) are transmitted in the time interval 450, the electronic device 301 may determine (or calculate) a first UL ReTX indicator in the time interval 450 (e.g., a ratio of pieces of data of which an uplink retransmission count is greater than or equal to the first count) (e.g., a ratio between the number of pieces of data transmitted in the time interval 450 and the number of pieces of data of which an uplink retransmission count is greater than or equal to the first count) to be 0.2 (= 2/10).

In the example illustrated in FIG. 4B, when the maximum count is, for example, four (4), the electronic device 301 may identify that the uplink retransmission count of the data β 456 reaches the maximum count (e.g., four (4)). Since the ten (10) pieces of data (e.g., the data α 451, the data β 452, the data β 453, the data β 454, the data β 455, the data β 456, the data γ 457, the data γ 458, the data γ 459, and the data δ 460) are transmitted in the time interval 450, the electronic device 301 may determine (or calculate) a second UL ReTX indicator in the time interval 450 (e.g., a ratio of pieces of data of which an uplink retransmission count reaches the maximum count) (e.g., a ratio between the number of pieces of data transmitted in the time interval 450 and the number of pieces of data of which an uplink retransmission count reaches the maximum count) to be 0.1 (= 1/10).

The electronic device 301 may transmit data (e.g., at least one voice packet) to the network 399 in the next time interval of the time interval 450 and determine (or calculate) an uplink retransmission indicator in the next time interval.

In the example above, the first count is set to three (3) and the maximum count is set to four (4), but these are only examples, and the first count is not limited to three (3) and the maximum count is not limited to four (4). According to an embodiment, the electronic device 301 may configure the maximum count based on the maxHARQ-Tx received from the network 399 (or the base station).

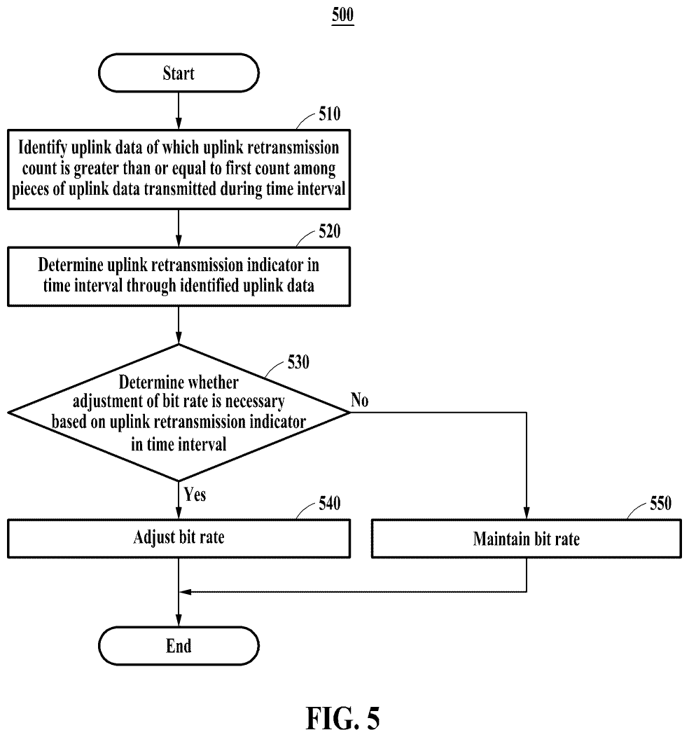

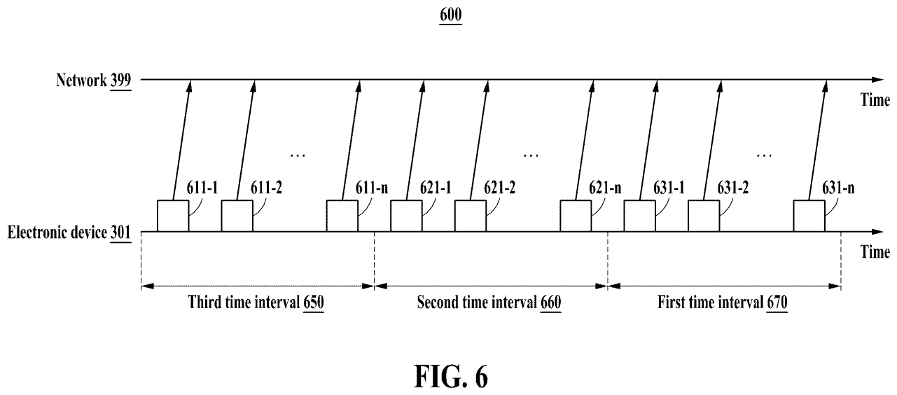

FIGS. 5 and 6 are diagrams illustrating an example of an operating method of an electronic device, according to an embodiment.

Uplink data described below may correspond to, for example, an uplink data packet.

Referring to FIG. 5, according to a method 500 of operating an electronic device 301, in operation 510, the electronic device 301 may identify uplink data of which an uplink retransmission count is greater than or equal to a first count among pieces of uplink data transmitted during a time interval (e.g., the time interval 450 of FIG. 4B).

In the example process 600, as illustrated in FIG. 6, the electronic device 301 may identify and/or check an uplink retransmission count of each of pieces of uplink data 611-1 to 611-n transmitted to the network 399 during a third time interval 650. The electronic device 301 may identify uplink data of which an uplink retransmission count is greater than or equal to the first count (e.g., four (4)) among the pieces of uplink data 611-1 to 611-n. The electronic device 301 may identify uplink data of which an uplink retransmission count is greater than or equal to the first count (e.g., four (4)) among pieces of uplink data 621-1 to 621-n transmitted to the network 399 during a second time interval 660. The electronic device 301 may identify uplink data of which an uplink retransmission count is greater than or equal to the first count (e.g., four (4)) among pieces of uplink data 631-1 to 631-n transmitted to the network 399 during a first time interval 670.

In operation 520, the electronic device 301 may determine an uplink retransmission indicator (e.g., a first UL ReTX indicator and/or a second UL ReTX indicator) in a time interval through the identified uplink data (e.g., uplink data of which an uplink retransmission count is greater than or equal to a first count in the time interval).

For example, in the example illustrated in FIG. 6, the electronic device 301 may determine a first UL ReTX indicator in the third time interval 650 (e.g., a ratio between the number of the pieces of uplink data 611-1 to 611-n and the number of pieces of uplink data of which an uplink retransmission count is greater than or equal to the first count among the number of the pieces of uplink data 611-1 to 611-n) and/or a second UL ReTX indicator in the third time interval 650 (e.g., a ratio between the number of the pieces of uplink data 611-1 to 611-n and the number of pieces of uplink data of which an uplink retransmission count reaches the maximum count among the pieces of uplink data 611-1 to 611-n).

The electronic device 301 may determine a first UL ReTX indicator in the second time interval 660 (e.g., a ratio between the number of the pieces of first to n-th second uplink data 621-1 to 621-n and the number of pieces of uplink data of which an uplink retransmission count is greater than or equal to the first count among the pieces of first to n-th second uplink data 621-1 to 621-n) and/or a second UL ReTX indicator in the second time interval 660 (e.g., a ratio between the number of the pieces of uplink data 621-1 to 621-n and the number of pieces of uplink data of which an uplink retransmission count reaches the maximum count among the pieces of uplink data 621-1 to 621-n).

The electronic device 301 may determine a first UL ReTX indicator in the first time interval 670 (e.g., a ratio between the number of the pieces of uplink data 631-1 to 631-n and the number of pieces of uplink data of which an uplink retransmission count is greater than or equal to the first count among the pieces of uplink data 631-1 to 631-n) and/or a second UL ReTX indicator in the first time interval 670 (e.g., a ratio between the number of the pieces of uplink data 631-1 to 631-n and the number of pieces of uplink data of which an uplink retransmission count reaches the maximum count among the pieces of uplink data 631-1 to 631-n).

In operation 530, the electronic device 301 may determine whether an adjustment of a bit rate (e.g., a bit rate of a codec) is necessary based on the uplink retransmission indicator (e.g., a first UL ReTX indicator and/or a second UL ReTX indicator) in the time interval.

For example, the electronic device 301 may determine whether the uplink retransmission indicator (e.g., a first UL ReTX indicator) in each of the consecutive time intervals (e.g., the third, second, and first time intervals 650, 660, and 670) is greater than or equal to a first threshold value (e.g., 0.2 or 20%). The first threshold value may represent, for example, but is not limited thereto, a threshold value that the electronic device 301 uses to determine whether to decrease the bit rate of the codec based on the first UL ReTX indicator.

As another example, the electronic device 301 may determine whether the uplink retransmission indicator (e.g., a second UL ReTX indicator) in one time interval (e.g., the first time interval 670) is greater than or equal to a third threshold value (e.g., 0.1 or 10%). The third threshold value may represent, for example, but is not limited thereto, a threshold value that the electronic device 301 uses to determine whether to decrease the bit rate of the codec based on the second UL ReTX indicator.

When the electronic device 301 determines that the adjustment of the bit rate is necessary (Yes at operation 530), in operation 540, the electronic device 301 may adjust the bit rate. Alternatively, when the electronic device 301 determines that the adjustment of the bit rate is not necessary (No at operation 530), in operation 550, the electronic device 301 may maintain the bit rate.

According to an embodiment, the electronic device 301 may determine that the first UL ReTX indicator in the first time interval 670 is greater than or equal to the first threshold value (e.g., 0.2 or 20%). Here, each of the first UL ReTX indicator in the second time interval 660 and the first UL ReTX indicator in the third time interval 650 may be greater than or equal to the first threshold value (e.g., 0.2 or 20%). The electronic device 301 may determine that the first UL ReTX indicator in each of the consecutive third, second, and first time intervals 650, 660, and 670 is greater than or equal to the first threshold value. In such a case, the electronic device 301 may adjust the bit rate to be relatively low and/or to lower the bit rate, in operation 540.

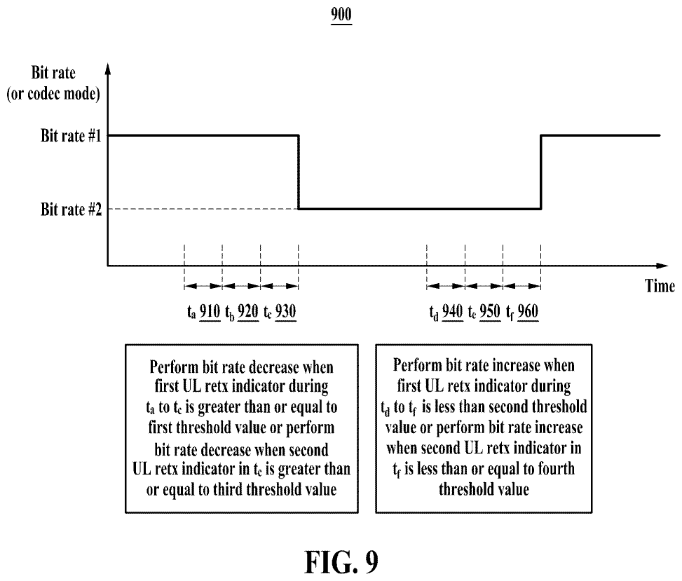

For example, bit rate #1 (e.g., bit rate #1 of FIG. 9) may be set in the codec. The electronic device 301 may determine the bit rate of the codec to be bit rate #2 (e.g., bit rate #2 of FIG. 9) by cooperating with the network 399 and/or a communication counterpart (e.g., the electronic device 104 of FIG. 1) of the electronic device 301 when the first UL ReTX indicator in each of the consecutive third, second, and first time intervals 650, 660, and 670 (e.g., time intervals tₐ, t_{b}, and t_{c} 910, 920, and 930 of FIG. 9) is greater than or equal to the first threshold value. The bit rate #2 may be lower than the bit rate #1. The electronic device 301 may change the bit rate of the codec from the bit rate #1 to the bit rate #2 when the bit rate of the codec is determined to be the bit rate #2.

The number of consecutive time intervals may be three (3), as in the example illustrated in FIG. 6, but this is only an example, and the number of consecutive time intervals may be two (2) or more. For example, the electronic device 301 may adjust the bit rate to be relatively low and/or to lower the bit rate, when the first UL ReTX indicator in each of the third and second time intervals 650 and 660 is greater than or equal to the first threshold value.

The electronic device 301 may determine whether the first UL ReTX indicator is less than a second threshold value (e.g., 0.2 or 20%) in each of the subsequent time intervals (e.g., time intervals between the end time of the time interval t_{c} 930 of FIG. 9 and the start time of a time interval t_{d} 940 of FIG. 9) of the first time interval 670. The second threshold value may represent, for example, but is not limited thereto, a threshold value that the electronic device 301 uses to determine whether to increase the bit rate of the codec based on the first UL ReTX indicator. In operation 550, the electronic device 301 may maintain the bit rate of the codec as the bit rate #2 when the first UL ReTX indicator is greater than or equal to the second threshold value in each subsequent time interval of the first time interval 670.

The first UL ReTX indicator in each of the time intervals (e.g., time intervals t_{d}, tₑ, and t_{f} 940, 950, and 960 of FIG. 9) may be less than the second threshold value while the bit rate of the codec is maintained as the bit rate #2. In such a case, the electronic device 301 may change the bit rate of the codec from the bit rate #2 to the bit rate #1. The electronic device 301 may restore the bit rate of the codec to a normal bit rate (e.g., the bit rate #1) when the first UL ReTX indicator in each of the time intervals (e.g., the time intervals t_{d}, tₑ, and t_{f} 940, 950, and 960 of FIG. 9) is less than the second threshold value.

In an embodiment, the second UL ReTX indicator in the second time interval 660 and the second UL ReTX indicator in the third time interval 650 may be less than a third threshold value (e.g., 0.1 or 10%). The electronic device 301 may determine that the second UL ReTX indicator in the first time interval 670 is greater than or equal to the third threshold value. The electronic device 301 may determine that a ratio (or number) of pieces of data of which an uplink retransmission count reaches the maximum count is greater than or equal to a predefined level (e.g., a level corresponding to the third threshold value) in the first time interval 670. In such a case, the electronic device 301 may adjust the bit rate to be relatively low and/or to lower the bit rate, in operation 540.

For example, the bit rate #1 (e.g., the bit rate #1 of FIG. 9) may be set in the codec. The electronic device 301 may determine the bit rate of the codec to be the bit rate #2 (e.g., the bit rate #2 of FIG. 9) by cooperating with the network 399 and/or a communication counterpart (e.g., the electronic device 104 of FIG. 1) of the electronic device 301 when the second UL ReTX indicator in the first time interval 670 (e.g., the time interval t_{c} 930 of FIG. 9) is greater than or equal to the third threshold value. The electronic device 301 may change the bit rate of the codec from the bit rate #1 to the bit rate #2 when the bit rate of the codec is determined to be the bit rate #2.

The electronic device 301 may determine whether the second UL ReTX indicator is less than or equal to a fourth threshold value (e.g., 0.02 or 2%) in each of the subsequent time intervals (e.g., time intervals between the end time of the time interval t_{c} 930 of FIG. 9 and the start time of the time interval t_{f} 960 of FIG. 9) of the first time interval 670 (e.g., the time interval t_{c} 930 of FIG. 9). The fourth threshold value may represent, for example, but is not limited thereto, a threshold value that the electronic device 301 uses to determine whether to increase the bit rate of the codec based on the second UL ReTX indicator. The electronic device 301 may maintain the bit rate of the codec as the bit rate #2 when the second UL ReTX indicator in each subsequent time interval of the first time interval 670 exceeds the fourth threshold value.

The second UL ReTX indicator in the time interval (e.g., the time interval t_{f} 960 of FIG. 9) may be less than or equal to the fourth threshold value while the bit rate of the codec is maintained as the bit rate #2. In such a case, the electronic device 301 may change the bit rate of the codec from the bit rate #2 to the bit rate #1.

According to an embodiment, the electronic device 301 may lower the bit rate of the codec step by step from the bit rate #1 (e.g., change from the bit rate #1 to the bit rate #2 and change from the bit rate #2 to bit rate #3 that is lower than the bit rate #2) and may recover the bit rate of the codec to the bit rate #1 by increasing the bit rate step by step (e.g., change from the bit rate #3 to the bit rate #2 and change from the bit rate #2 to the bit rate #1).

The electronic device 301 according to an embodiment may perform operations 510 to 550 for each specified time interval (e.g., the first time interval 670, the second time interval 660, and/or the third time interval 650).

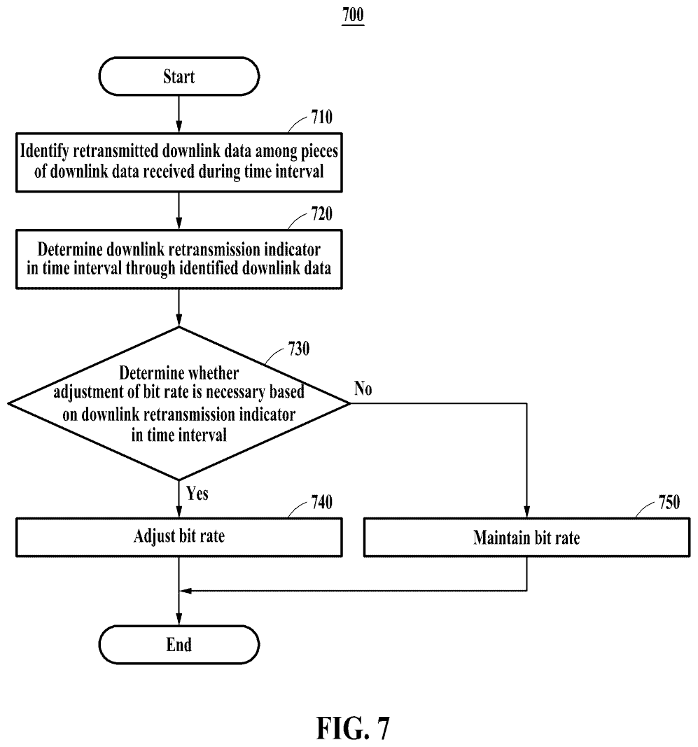

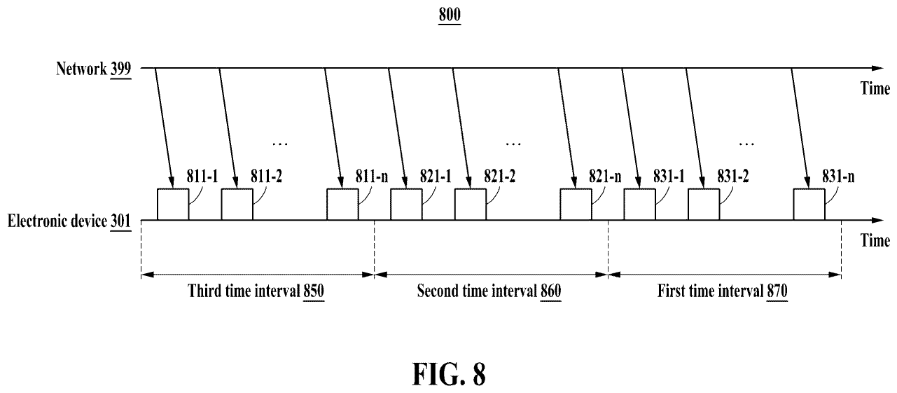

FIGS. 7 and 8 are diagrams illustrating an example of an operating method of an electronic device, according to an embodiment.

Downlink data described below may correspond to, for example, a downlink data packet.

Referring to FIG. 7, according to an operating method 700, in operation 710, the electronic device 301 may identify retransmitted downlink data (or discarded downlink data) among pieces of downlink data received during a time interval.

In the example process 800, as illustrated in FIG. 8, the electronic device 301 may identify downlink data (or discarded data among pieces of downlink data 811-1 to 811-n) retransmitted from a network among the pieces of downlink data 811-1 to 811-n that are received from the network 399 during a third time interval 850 (e.g., the third time interval 650 of FIG. 6). The electronic device 301 may identify downlink data (or discarded data among pieces of downlink data 821-1 to 821-n) retransmitted from the network among the pieces of downlink data 821-1 to 821-n that are received from the network 399 during a second time interval 860 (e.g., the second time interval 660 of FIG. 6). The electronic device 301 may identify downlink data (or discarded data) retransmitted from the network among pieces of downlink data 831-1 to 831-n that are received from the network 399 during a first time interval 870 (e.g., the first time interval 670 of FIG. 6).

In operation 720, the electronic device 301 may determine a downlink retransmission indicator (e.g., a downlink retransmission number and/or a downlink retransmission ratio) in the time interval through the identified downlink data (or discarded downlink data).

For example, in the example illustrated in FIG. 8, the electronic device 301 may determine a downlink retransmission number (or a first DL ReTX indicator) (e.g., the number of pieces of downlink data retransmitted from among the pieces of downlink data 811-1 to 811-n) in the third time interval 850 and/or a downlink retransmission ratio (or a second DL ReTX indicator) (e.g., a ratio between the number of the pieces of downlink data 811-1 to 811-n and the downlink retransmission number in the third time interval 850).

The electronic device 301 may determine a downlink retransmission number (e.g., the number of pieces of downlink data retransmitted from among the pieces of downlink data 821-1 to 821-n) in the second time interval 860 and/or a downlink retransmission ratio (e.g., a ratio between the number of the pieces of downlink data 821-1 to 821-n and the downlink retransmission number in the second time interval 860).

The electronic device 301 may determine a downlink retransmission number (e.g., the number of pieces of downlink data retransmitted from among the pieces of downlink data 831-1 to 831-n) in the first time interval 870 and/or a downlink retransmission ratio (e.g., a ratio between the number of the pieces of downlink data 831-1 to 831-n and the downlink retransmission number in the first time interval 870).

In operation 730, the electronic device 301 may determine whether an adjustment of a bit rate (e.g., a bit rate of a codec) is necessary based on the downlink retransmission indicator (e.g., a downlink retransmission number and/or a downlink retransmission ratio) in the time interval.

For example, the electronic device 301 may determine whether the number of pieces of retransmitted downlink data in one time interval (e.g., the first time interval 870 of FIG. 8) is greater than or equal to the number of pieces of downlink data that does not correspond to downlink retransmission.

As another example, the electronic device 301 may determine whether the downlink retransmission indicator (e.g., a downlink retransmission ratio) in each of the consecutive time intervals (e.g., the third, second, and first time intervals 850, 860, and 870 of FIG. 8) is greater than or equal to a fifth threshold value (e.g., 0.4 or 40%). The fifth threshold value may represent, for example, but is not limited thereto, a threshold value that the electronic device 301 uses to determine whether to decrease the bit rate of the codec based on the downlink retransmission ratio.

When the electronic device 301 determines that the adjustment of the bit rate is necessary (Yes at operation 730), in operation 740, the electronic device 301 may adjust the bit rate. When the electronic device 301 determines that the adjustment of the bit rate is not necessary (No at operation 730), in operation 750, the electronic device 301 may maintain the bit rate.

According to an embodiment, the electronic device 301 may determine that the downlink retransmission ratio in the first time interval 870 is greater than or equal to the fifth threshold value (e.g., 0.4 or 40%). Here, each of the downlink retransmission ratio in the second time interval 860 and the downlink retransmission ratio in the third time interval 850 may be greater than or equal to the fifth threshold value (e.g., 0.4 or 40%). In such a case, the electronic device 301 may adjust the bit rate to be relatively low and/or to lower the bit rate.

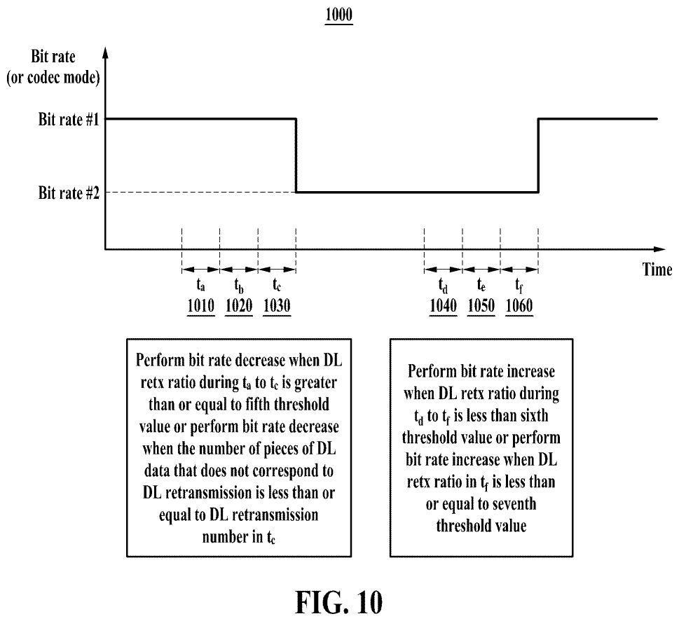

For example, bit rate #1 (e.g., the bit rate #1 of FIG. 10) may be set in the codec. The electronic device 301 may determine the bit rate of the codec to be bit rate #2 (e.g., the bit rate #2 of FIG. 10) by cooperating with the network 399 and/or a communication counterpart (e.g., the electronic device 104 of FIG. 1) of the electronic device 301 when the downlink retransmission ratio in each of the consecutive third, second, and first time intervals 850, 860, and 870 (e.g., time intervals tₐ, t_{b}, and t_{c} 1010, 1020, and 1030 of FIG. 10) is greater than or equal to the fifth threshold value. The electronic device 301 may change the bit rate of the codec from the bit rate #1 to the bit rate #2 when the bit rate of the codec is determined to be the bit rate #2.

The number of consecutive time intervals may be three (3), as in the example illustrated in FIG. 8, but this is only an example, and the number of consecutive time intervals may be two (2) or more. For example, the electronic device 301 may adjust the bit rate to be relatively low and/or to lower the bit rate, when the downlink retransmission ratio in each of the third and second time intervals 850 and 860 is greater than or equal to the fifth threshold value.

The electronic device 301 may determine whether the downlink retransmission ratio is less than a sixth threshold value (e.g., 0.4 or 40%) in each of the subsequent time intervals (e.g., time intervals between the end time of the time interval t_{c} 1030 of FIG. 10 and the start time of a time interval t_{d} 1040 of FIG. 10) of the first time interval 870 (e.g., the time interval t_{c} 1030 of FIG. 10). The sixth threshold value may represent, but is not limited thereto, a threshold value that the electronic device 301 uses to determine whether to increase the bit rate of the codec based on the downlink retransmission ratio in a situation in which a state of the network does not change rapidly (e.g., No at operation 1210). In operation 750, the electronic device 301 may maintain the bit rate of the codec as the bit rate #2 when the downlink retransmission ratio is greater than or equal to the sixth threshold value in each subsequent time interval of the first time interval 870.

The downlink retransmission ratio in each of the time intervals (e.g., time intervals t_{d}, tₑ, and t_{f} 1040, 1050, and 1060 of FIG. 10) may be less than the sixth threshold value while the bit rate of the codec is maintained as the bit rate #2. In such a case, the electronic device 301 may change the bit rate of the codec from the bit rate #2 to the bit rate #1.

According to an embodiment, in operation 730, the electronic device 301 may determine that the number of pieces of retransmitted downlink data in the first time interval 870 (e.g., the time interval t_{c} 1030 of FIG. 10) is greater than the number of pieces of downlink data that does not correspond to downlink retransmission (or the rest of the pieces of downlink data 831-1 to 831-n, excluding retransmitted downlink data) among the pieces of downlink data 831-1 to 831-n of the first time interval 870. In such a case, the electronic device 301 may adjust the bit rate of the codec from the bit rate #1 (e.g., the bit rate #1 of FIG. 10) to the bit rate #2 (e.g., the bit rate #2 of FIG. 10).

The electronic device 301 may determine whether the downlink retransmission ratio is less than a seventh threshold value (e.g., 0.05 or 5%) in each of the subsequent time intervals (e.g., time intervals between the end time of the time interval t_{c} 1030 of FIG. 10 and the start time of the time interval t_{f} 1060 of FIG. 10) of the first time interval 870. The seventh threshold value may represent, but is not limited thereto, a threshold value that the electronic device 301 uses to determine whether to increase the bit rate of the codec based on the downlink retransmission ratio in a situation in which the state of the network changes rapidly (e.g., Yes at operation 1210). The electronic device 301 may maintain the bit rate of the codec as the bit rate #2 when the downlink retransmission ratio exceeds the seventh threshold value in each subsequent time interval of the first time interval 870.

The downlink retransmission ratio may be less than or equal to the seventh threshold value in the time interval (e.g., the time interval t_{f} 1060 of FIG. 10) while the bit rate of the codec is maintained as the bit rate #2. In such a case, the electronic device 301 may change the bit rate of the codec from the bit rate #2 to the bit rate #1.

The electronic device 301 according to an embodiment may perform operations 710 to 750 for each specified time interval (e.g., the first time interval 870, the second time interval 860, and/or the third time interval 850).

FIG. 9 is a diagram illustrating an example of an operation in which an electronic device adjusts a bit rate based on an uplink retransmission indicator, according to an embodiment.

In the example process 900, as illustrated in FIG. 9, the electronic device 301 may perform encoding (or compression) on a voice signal at bit rate #1 through a codec and may transmit, to a network, uplink data (e.g., voice data or voice packets) generated based on the encoding. The codec may be, but is not limited thereto, an adaptive multi-rate wideband (AMR WB), for example.

According to an embodiment, the electronic device 301 may adjust the bit rate of the codec based on a first UL ReTX indicator (e.g., a ratio of pieces of uplink data of which an uplink retransmission count is greater than or equal to a first count) in each of the time intervals tₐ, t_{b}, and t_{c} 910, 920, and 930. For example, the electronic device 301 may determine the first UL ReTX indicator in each of the time intervals tₐ, t_{b}, and t_{c} 910, 920, and 930. The electronic device 301 may perform a bit rate decrease (or adjust the bit rate of the codec to be relatively low and/or to lower the bit rate), when the first UL ReTX indicator in each of the time intervals tₐ, t_{b}, and t_{c} 910, 920, and 930 is greater than or equal to a first threshold value. The electronic device 301 may adjust (or change) the bit rate of the codec from the bit rate #1 to bit rate #2 when the first UL ReTX indicator in each of the time intervals tₐ, t_{b}, and t_{c} 910, 920, and 930 is greater than or equal to the first threshold value. The bit rate #2 may be lower than the bit rate #1. The electronic device 301 may maintain the bit rate of the codec as the bit rate #1 when the first UL ReTX indicator in each of the time intervals tₐ and t_{b} 910 and 920 is greater than or equal to the first threshold value and the first UL ReTX indicator in the time interval t_{c} 930 is less than the first threshold value.

According to an embodiment, the electronic device 301 may adjust the bit rate of the codec based on a second UL ReTX indicator (e.g., a ratio of pieces of uplink data of which an uplink retransmission count reaches the maximum count) in the time interval t_{c} 930. For example, a second UL ReTX indicator in each of the time intervals tₐ and t_{b} 910 and 920 may be less than a third threshold value (e.g., 0.1 or 10%), and a second UL ReTX indicator in the time interval t_{c} 930 may be greater than or equal to the third threshold value (e.g., 0.1 or 10%). The electronic device 301 may perform a bit rate decrease (or adjust the bit rate of the codec to be relatively low and/or to lower the bit rate), when the second UL ReTX indicator in the time interval t_{c} 930 is greater than or equal to the third threshold value. The electronic device 301 may adjust (or change) the bit rate of the codec from the bit rate #1 to the bit rate #2 when the second UL ReTX indicator in the time interval t_{c} 930 is greater than or equal to the third threshold value.

According to an embodiment, when the bit rate of the codec is adjusted from the bit rate #1 to the bit rate #2, the electronic device 301 may perform encoding (or compression) on a voice signal at the bit rate #2 through the codec and may transmit, to the network, uplink data generated based on the encoding.

According to an embodiment, the electronic device 301 may adjust the bit rate of the codec based on a first UL ReTX indicator (e.g., a ratio of pieces of uplink data of which an uplink retransmission count is greater than or equal to the first count) in each of the time intervals t_{d}, tₑ, and t_{f} 940, 950, and 960. For example, the electronic device 301 may determine the first UL ReTX indicator in each of the time intervals t_{d}, tₑ, and t_{f} 940, 950, and 960. The electronic device 301 may perform a bit rate increase (or adjust the bit rate of the codec to be relatively high and/or to increase the bit rate), when the first UL ReTX indicator in each of the time intervals t_{d}, tₑ, and t_{f} 940, 950, and 960 is less than a second threshold value (e.g., 0.2 or 20%). The electronic device 301 may adjust (or change) the bit rate of the codec from the bit rate #2 to the bit rate #1 when the first UL ReTX indicator in each of the time intervals t_{d}, tₑ, and t_{f} 940, 950, and 960 is less than the second threshold value. The electronic device 301 may maintain the bit rate of the codec as the bit rate #2 when the first UL ReTX indicator in each of the time intervals t_{d} and tₑ 940 and 950 is less than the second threshold value and the first UL ReTX indicator in the time interval t_{f} 960 is greater than the second threshold value.

According to an embodiment, the electronic device 301 may adjust the bit rate of the codec based on a second UL ReTX indicator (e.g., a ratio of pieces of uplink data of which an uplink retransmission count reaches the maximum count) in the time interval t_{f} 960. For example, a second UL ReTX indicator in each of the time intervals t_{d} and tₑ 940 and 950 may exceed a fourth threshold value (e.g., 0.02 or 2%), and a second UL ReTX indicator in the time interval t_{f} 960 may be less than or equal to the fourth threshold value (e.g., 0.02 or 2%). The electronic device 301 may adjust (or perform a bit rate increase) the bit rate of the codec to be relatively high and/or to increase the bit rate, when the second UL ReTX indicator in the time interval t_{f} 960 is less than or equal to the fourth threshold value. The electronic device 301 may adjust (or change) the bit rate of the codec from the bit rate #2 to the bit rate #1 when the second UL ReTX indicator in the time interval t_{f} 960 is less than or equal to the fourth threshold value. The electronic device 301 may maintain the bit rate of the codec as the bit rate #2 when the second UL ReTX indicator in the time interval t_{f} 960 is greater than the fourth threshold value.

According to an embodiment, when the bit rate of the codec is adjusted from the bit rate #2 to the bit rate #1, the electronic device 301 may perform encoding (or compression) on a voice signal at the bit rate #1 and may transmit, to the network, uplink data generated based on the encoding.

According to an embodiment, the first threshold value and the second threshold value may be the same. However, embodiments are not limited thereto, and the first threshold value and the second threshold value may be different.

According to an embodiment, the third threshold value and the fourth threshold value may be the same. However, embodiments are not limited thereto, and the third threshold value and the fourth threshold value may be different.

According to an embodiment, the electronic device 301 may immediately perform a bit rate decrease when a bit rate decrease condition of FIG. 9 (e.g., a condition in which the first UL ReTX indicator in each of the time intervals tₐ, t_{b}, and t_{c} 910, 920, and 930 is greater than or equal to the first threshold value or a condition in which the second UL ReTX indicator in the time interval t_{c} 930 is greater than or equal to the third threshold value) is satisfied. However, embodiments are not limited thereto, and the electronic device 301 may perform a bit rate decrease after a predefined time delay when the bit rate decrease condition of FIG. 9 is satisfied.

According to an embodiment, the electronic device 301 may immediately perform a bit rate increase when a bit rate increase condition of FIG. 9 (e.g., a condition in which the first UL ReTX indicator in each of the time intervals t_{d}, tₑ, and t_{f} 940, 950, and 960 is less than the second threshold value or a condition in which the second UL ReTX indicator in the time interval t_{f} 960 is less than or equal to the fourth threshold value) is satisfied. However, embodiments are not limited thereto, and the electronic device 301 may perform a bit rate increase after a predefined time delay when the bit rate increase condition of FIG. 9 is satisfied.

According to an embodiment, the electronic device 301 may immediately perform a bit rate decrease when the bit rate decrease condition of FIG. 9 is satisfied, and when the bit rate increase condition of FIG. 9 is satisfied, the electronic device 301 may perform a bit rate increase after a predefined time delay or immediately perform a bit rate increase. Alternatively, the electronic device 301 may perform a bit rate decrease after a predefined time delay when the bit rate decrease condition of FIG. 9 is satisfied, and when the bit rate increase condition of FIG. 9 is satisfied, the electronic device 301 may perform a bit rate increase after a predefined time delay or immediately perform a bit rate increase.

FIG. 10 is a diagram illustrating an example of an operation in which an electronic device adjusts a bit rate based on a downlink retransmission indicator, according to an embodiment.

In the example process 1000, as illustrated in FIG. 10, the electronic device 301 may perform decoding on downlink data (e.g., voice data or voice packets) at bit rate #1 through a codec and may provide a signal (e.g., a voice signal) generated by the decoding to a user.

According to an embodiment, the electronic device 301 may adjust the bit rate of the codec based on a downlink retransmission (DL ReTX) rate in each of the time intervals tₐ, t_{b}, and t_{c} 1010, 1020, and 1030. For example, the electronic device 301 may determine the downlink retransmission ratio in each of the time intervals tₐ, t_{b}, and t_{c} 1010, 1020, and 1030. The electronic device 301 may determine whether the downlink retransmission ratio in each of the time intervals tₐ, t_{b}, and t_{c} 1010, 1020, and 1030 is greater than or equal to a fifth threshold value (e.g., 0.4 or 40%). The electronic device 301 may perform a bit rate decrease (or adjust the bit rate of the codec to be relatively low and/or to lower the bit rate), when the downlink retransmission ratio in each of the time intervals tₐ, t_{b}, and t_{c} 1010, 1020, and 1030 is greater than or equal to the fifth threshold value (e.g., 0.4 or 40%).

According to an embodiment, the electronic device 301 may adjust the bit rate of the codec based on the number of pieces of retransmitted downlink data in the time interval t_{c} 1030 and the number of pieces of downlink data that does not correspond to downlink retransmission. For example, the electronic device 301 may determine whether the number of pieces of retransmitted downlink data in the time interval t_{c} 1030 is greater than or equal to the number of pieces of downlink data that does not correspond to downlink retransmission. The electronic device 301 may adjust perform a bit rate decrease (or adjust the bit rate of the codec to be relatively low and/or to lower the bit rate), when the number of pieces of retransmitted downlink data in the time interval t_{c} 1030 is greater than or equal to the number of pieces of downlink data that does not correspond to downlink retransmission. The electronic device 301 may adjust (or change) the bit rate of the codec from the bit rate #1 to bit rate #2.

According to an embodiment, when the bit rate of the codec is adjusted from the bit rate #1 to the bit rate #2, the electronic device 301 may perform decoding on downlink data at the bit rate #2 through the codec and may provide a signal (e.g., a voice signal) generated based on the decoding to the user.

According to an embodiment, the electronic device 301 may adjust the bit rate of the codec based on a downlink retransmission ratio in each of the time intervals t_{d}, tₑ, and t_{f} 1040, 1050, and 1060. For example, the electronic device 301 may determine the downlink retransmission ratio in each of the time intervals t_{d}, tₑ, and t_{f} 1040, 1050, and 1060. The electronic device 301 may determine whether the downlink retransmission ratio in each of the time intervals t_{d}, tₑ, and t_{f} 1040, 1050, and 1060 is less than a sixth threshold value (e.g., 0.4 or 40%). The electronic device 301 may perform a bit rate increase (or adjust the bit rate of the codec to be relatively high and/or to increase the bit rate), when the downlink retransmission ratio in each of the time intervals t_{d}, tₑ, and t_{f} 1040, 1050, and 1060 is less than the sixth threshold value (e.g., 0.4 or 40%). The electronic device 301 may adjust the bit rate of the codec from the bit rate #2 to the bit rate #1.

According to an embodiment, the electronic device 301 may adjust the bit rate of the codec based on the downlink retransmission ratio in the time interval t_{f} 1060. For example, the electronic device 301 may determine whether the downlink retransmission ratio in the time interval t_{f} 1060 is less than or equal to a seventh threshold value (e.g., 0.05 or 5%). The electronic device 301 may perform a bit rate increase (or adjust the bit rate of the codec to be relatively high and/or to increase the bit rate), when the downlink retransmission ratio in the time interval t_{f} 1060 is less than or equal to the seventh threshold value. The electronic device 301 may adjust the bit rate of the codec from the bit rate #2 to the bit rate #1.

According to an embodiment, when the bit rate of the codec is adjusted from the bit rate #2 to the bit rate #1, the electronic device 301 may perform decoding on downlink data at the bit rate #1 and may provide a signal generated based on the decoding to the user.

In an embodiment, the fifth threshold value and the sixth threshold value may be the same. However, embodiments are not limited thereto, the fifth threshold value and the sixth threshold value may be different.

According to an embodiment, the electronic device 301 may immediately perform a bit rate decrease when a bit rate decrease condition of FIG. 10 (e.g., a condition in which the downlink retransmission ratio during the time intervals tₐ, t_{b}, and t_{c} 1010, 1020, and 1030 is greater than or equal to the fifth threshold value or a condition in which the number of pieces of retransmitted downlink data in the time interval t_{c} 1030 is greater than or equal to the number of pieces of downlink data that does not correspond to downlink retransmission) is satisfied. However, embodiments are not limited thereto, and the electronic device 301 may perform a bit rate decrease after a predefined time delay when the bit rate decrease condition of FIG. 10 is satisfied.

According to an embodiment, the electronic device 301 may immediately perform a bit rate increase when a bit rate increase condition of FIG. 10 (e.g., a condition in which the downlink retransmission ratio during the time intervals t_{d}, tₑ, and t_{f} 1040, 1050, and 1060 is less than the sixth threshold value or a condition in which the downlink retransmission ratio in the time interval t_{f} 1060 is less than or equal to the seventh threshold value) is satisfied. However, embodiments are not limited thereto, and the electronic device 301 may perform a bit rate increase after a predefined time delay when the bit rate increase condition of FIG. 10 is satisfied.

According to an embodiment, the electronic device 301 may immediately perform a bit rate decrease when the bit rate decrease condition of FIG. 10 is satisfied, and when the bit rate increase condition of FIG. 10 is satisfied, the electronic device 301 may perform a bit rate increase after a predefined time delay or immediately perform a bit rate increase. Alternatively, the electronic device 301 may perform a bit rate decrease after a predefined time delay when the bit rate decrease condition of FIG. 10 is satisfied, and when the bit rate increase condition of FIG. 10 is satisfied, the electronic device 301 may perform a bit rate increase after a predefined time delay or immediately perform a bit rate increase.

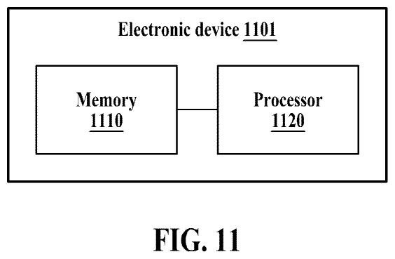

FIG. 11 is a block diagram illustrating an example of a configuration of an electronic device, according to an embodiment.

Referring to FIG. 11, an electronic device 1101 may include and/or may be similar in many respects to the electronic devices 101, 201, and 301 described above with reference to FIGS. 1, 2, 3A, 3B, 4A, 4B, and 5 to 10, and may include additional features not mentioned above. Consequently, repeated descriptions of the electronic device 1101 described above with reference to FIGS. 1, 2, 3A, 3B, 4A, 4B, and 5 to 10 may be omitted for the sake of brevity.

As shown in FIG. 11, according to an embodiment, an electronic device 1101 may include memory 1110 (e.g., the memory 130 of FIG. 1) and a processor 1120 (e.g., the processor 120 of FIG. 1 and the processor 210 of FIG. 2).

The processor 1120 may include processing circuitry.

The processor 1120 may be operatively connected to the memory 1110.

The memory 1110 may store one or more instructions executable by the

processor 1120. The one or more instructions, when executed by the processor 1120, may cause the electronic device 1101 to perform the operations of the electronic device 1101.

According to an embodiment, the processor 1120 or the memory 1110 may include a voice engine. The processor 1120 may execute the voice engine. The processor 1120 may process received downlink data through the voice engine to generate a voice signal and provide the voice signal to a user. The processor 1120 may process the voice signal received from the user through the voice engine to generate uplink data and transmit the generated uplink data to a network.

According to an embodiment, the processor 1120 may identify first uplink data of which an uplink retransmission count is greater than or equal to a first count among pieces of uplink data transmitted during a time interval.

According to an embodiment, the processor 1120 may determine an indicator (e.g., a first UL ReTX indicator) regarding uplink retransmission in the time interval through the identified first uplink data. For example, the processor 1120 may calculate a first ratio (e.g., a first UL ReTX indicator) between the number of pieces of uplink data transmitted during the time interval (e.g., the first time interval 670 of FIG. 6) and the number of pieces of first uplink data.

According to an embodiment, the processor 1120 may calculate a second ratio (e.g., a second UL ReTX indicator) between the number of pieces of uplink data of which an uplink retransmission count reaches the maximum count in the time interval (e.g., the first time interval 670 of FIG. 6) and the number of pieces of uplink data transmitted during the time interval (e.g., the first time interval 670 of FIG. 6).

According to an embodiment, the processor 1120 may determine whether an adjustment of a bit rate (e.g., a bit rate used for encoding and/or decoding) is necessary based on the indicator regarding the uplink retransmission in the time interval.

For example, the processor 1120 may determine whether each of the calculated first ratio in the time interval (e.g., the first time interval 670 of FIG. 6) and a ratio between the number of pieces of second uplink data of which an uplink retransmission count is greater than or equal to the first count among pieces of uplink data transmitted during at least one previous time interval (e.g., the second time interval 660 and/or the third time interval 650 of FIG. 6) of the time interval (e.g., the first time interval 670 of FIG. 6) and the number of pieces of uplink data transmitted during the previous time interval is greater than or equal to a first threshold value or less than a second threshold value.

As another example, the processor 1120 may determine whether the calculated second ratio is greater than or equal to a third threshold value or less than or equal to a fourth threshold value.

In an embodiment, the processor 1120 may adjust the bit rate when the electronic device 1101 determines that the adjustment of the bit rate is necessary.

For example, when each of the calculated first ratio during the time interval and the ratio between the number of pieces of second uplink data of which an uplink retransmission count is greater than or equal to the first count among the pieces of transmitted uplink data during the previous time interval and the number of pieces of transmitted uplink data during the previous time interval is greater than or equal to the first threshold value, the processor 1120 may adjust the bit rate to be low. Alternatively, when each of the calculated first ratio during the time interval and the ratio is less than the second threshold value, the processor 1120 may adjust the bit rate to be high.

As another example, the processor 1120 may adjust the bit rate to be low when the calculated second ratio during the time interval is greater than or equal to the third threshold value or may adjust the bit rate to be high when the calculated second ratio during the time interval is less than or equal to the fourth threshold value.

According to an embodiment, the processor 1120 may identify first downlink data retransmitted from among pieces of downlink data that are received during the time interval.

According to an embodiment, the processor 1120 may determine an indicator (e.g., a downlink retransmission number and/or a downlink retransmission ratio) regarding downlink retransmission in the time interval through the identified first downlink data.

For example, the processor 1120 may calculate a third ratio (e.g., a downlink retransmission ratio) between the number of pieces of downlink data received in the time interval (e.g., the first time interval 870 of FIG. 8) and the number of pieces of identified first downlink data.

In an embodiment, the processor 1120 may determine whether the adjustment of the bit rate is necessary based on the indicator regarding the downlink retransmission. The processor 1120 may adjust the bit rate when the electronic device 1101 determines that the adjustment of the bit rate is necessary.

For example, the processor 1120 may calculate a ratio between the number of pieces of second downlink data retransmitted from among pieces of downlink data that are received during at least one previous time interval (e.g., the second time interval 860 and/or the third time interval 850 of FIG. 8) of the time interval (e.g., the first time interval 870 of FIG. 8) and the number of pieces of downlink data received during the previous time interval and may determine whether each of the calculated ratio during the previous time interval and the calculated third ratio during the time interval is greater than or equal to a fifth threshold value or less than a sixth threshold value. When each of the calculated ratio (e.g., the ratio between the number of pieces of second downlink data retransmitted from among the pieces of downlink data that are received during the previous time interval and the number of pieces of downlink data received during the previous time interval) and the calculated third ratio is greater than or equal to the fifth threshold value, the processor 1120 may adjust the bit rate to be low. Alternatively, when each of the calculated ratio and the calculated third ratio is less than the sixth threshold value, the processor 1120 may adjust the bit rate to be high.

As another example, the processor 1120 may determine whether the calculated third ratio during the time interval is less than or equal to a seventh threshold value. The processor 1120 may adjust the bit rate to be high when the calculated third ratio is less than or equal to the seventh threshold value.

As another example, the processor 1120 may determine whether the number of pieces of remaining data among the pieces of downlink data that are received in the time interval, other than the number of pieces of first downlink data, is less than the number of pieces of first downlink data. The processor 1120 may adjust the bit rate to be low when the number of pieces of remaining data is less than the number of pieces of first downlink data.

According to an embodiment, the electronic device 1101 may check a packet transmission state or a packet reception state and perform a rate adaptation in a situation in which there is a problem with voice quality by considering the packet transmission state or the packet reception state.

According to an embodiment, an electric field state between the electronic device 1101 and the network may be a first electric field state (e.g., a weak electric field state in which the strength of a signal received from the network is less than or equal to a first level). The electronic device 1101 may perform a rate adaptation (e.g., an increase of the bit rate or a decrease of the bit rate) using the uplink retransmission indicator and/or the downlink retransmission indicator when the electric field state is the first electric field state.

According to an embodiment, an electric field state between the electronic device 1101 and the network may be a second electric field state (e.g., a strong electric field state in which the strength of a signal received from the network is greater than or equal to a second level). In a state in which the electric field state is the second electric field state, the electronic device 1101 may perform a rate adaptation when the uplink retransmission indicator is less than or equal to a predefined level (e.g., when a first UL ReTX indicator in each of the consecutive time intervals is greater than or equal to the first threshold value or when a second UL ReTX indicator in a certain time interval is less than or equal to the third threshold value) or when the downlink retransmission indicator is less than or equal to a predefined level (e.g., when a downlink retransmission ratio in each of the consecutive time intervals is greater than or equal to the fifth threshold value or when the number of pieces of downlink data retransmitted in a certain time interval is greater than or equal to the number of pieces of remaining data, other than the retransmitted downlink data).

In an embodiment, interference may occur between the electronic device 1101 and the network, or the network environment (or the state of the network) may be rapidly changed. For example, the electronic device 1101 may move quickly, move into an elevator, or move out of an elevator. When interference occurs between the electronic device 1101 and the network or the network environment (or the state of the network) changes rapidly, the uplink retransmission indicator and/or the downlink retransmission indicator may be less than or equal to a predefined level. In such a case, the electronic device 1101 may perform a rate adaptation.

The embodiments described with reference to FIGS. 1, 2, 3A, 3B, 4A, 4B, and 5 to 10 may be applied to the electronic device 1101 of FIG. 11.

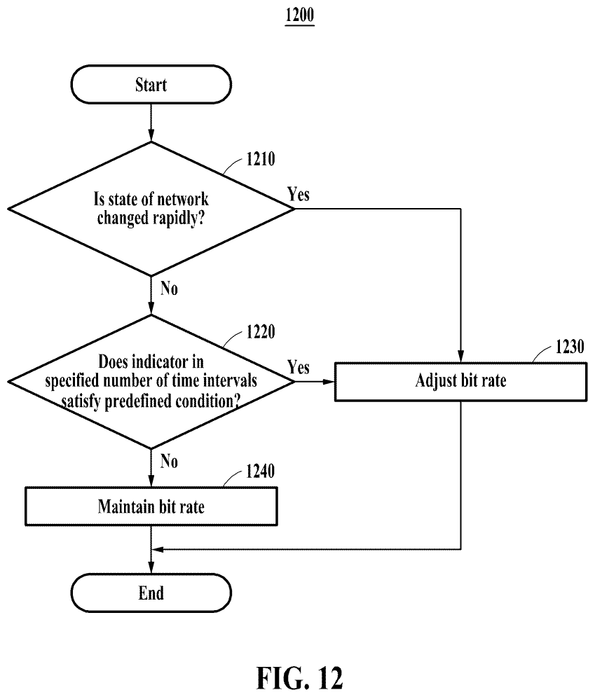

FIG. 12 is a flowchart illustrating an example of an operating method 1200 of an electronic device, according to an embodiment.

The operating method 1200 described with reference to FIG. 12 may be performed by an electronic device (e.g., the electronic device 101 of FIG. 1, the electronic device 201 of FIG. 2, the electronic device 301 of FIGS. 3A, 3B, 4A, 4B, and 5 to 10, and the electronic device 1101 of FIG. 11).

Referring to FIG. 12, in operation 1210, the electronic device may determine whether a state (e.g., an electric field state) of a network (e.g., the network 399 of FIGS. 3B and 4B) is rapidly changed.

In an embodiment, the electronic device may determine whether the state of the network is rapidly changed based on a second UL ReTX indicator.

For example, the electronic device may determine that the state of the network is rapidly changed (e.g., deteriorated) when the second UL ReTX indicator in a time interval (e.g., the time interval t_{b} 920 of FIG. 9) is less than a third threshold value and the second UL ReTX indicator in a time interval (e.g., the time interval t_{c} 930 of FIG. 9) is greater than or equal to the third threshold value.

For example, the electronic device may determine that the state of the network is rapidly changed (e.g., improved) when the second UL ReTX indicator in a time interval (e.g., the time interval tₑ 950 of FIG. 9) exceeds a fourth threshold value and the second UL ReTX indicator in a time interval (e.g., the time interval t_{f} 960 of FIG. 9) is less than or equal to the fourth threshold value.

In an embodiment, the electronic device may determine whether the state of the network is rapidly changed based on a downlink retransmission number.

For example, the electronic device may determine that the state of the network is rapidly changed (e.g., deteriorated) when the downlink retransmission number in a time interval (e.g., the time interval t_{b} 1020 of FIG. 10) is less than the number of pieces of downlink data that does not correspond to downlink retransmission and the downlink retransmission number in a time interval (e.g., the time interval t_{c} 1030 of FIG. 10) is greater than or equal to the number of pieces of downlink data that does not correspond to downlink retransmission.

In an embodiment, the electronic device may determine whether the state of the network is rapidly changed based on a downlink retransmission ratio.

For example, the electronic device may determine that the state of the network is rapidly changed (e.g., improved) when the downlink retransmission ratio in a time interval (e.g., the time interval tₑ 1050 of FIG. 10) exceeds a seventh threshold value and the downlink retransmission ratio in a time interval (e.g., the time interval t_{f} 1060 of FIG. 10) is less than or equal to the seventh threshold value.

In operation 1230, the electronic device may adjust a bit rate of a codec when the electronic device 301 determines that the state of the network is rapidly changed (Yes at operation 1210).

For example, the electronic device may adjust the bit rate of the codec from bit rate #1 (e.g., the bit rate #1 of FIG. 9) to bit rate #2 (e.g., the bit rate #2 of FIG. 9) when the electronic device 301 determines that the state of the network is rapidly deteriorated based on the second UL ReTX indicator.

For example, the electronic device may adjust the bit rate of the codec from the bit rate #2 to the bit rate #1 when the electronic device determines that the state of the network is rapidly improved based on the second UL ReTX indicator.

For example, the electronic device may adjust the bit rate of the codec from the bit rate #1 (e.g., the bit rate #1 of FIG. 10) to the bit rate #2 (e.g., the bit rate #2 of FIG. 10) when the electronic device determines that the state of the network is rapidly deteriorated based on the downlink retransmission number.

For example, the electronic device may adjust the bit rate of the codec from the bit rate #2 to the bit rate #1 when the electronic device determines that the state of the network is rapidly improved based on the downlink retransmission ratio.

In operation 1220, the electronic device may determine whether an indicator (e.g., a first UL ReTX indicator and a downlink retransmission ratio) in the specified number of time intervals satisfies a predefined condition when the electronic device determines that the state of the network is not rapidly changed (No at operation 1210).

According to an embodiment, the predefined condition may include at least one of or all of, for example, a first condition in which the first UL ReTX indicator in each of the consecutive time intervals (e.g., the time intervals tₐ, t_{b}, and t_{c} 910, 920, and 930 of FIG. 9) is greater than or equal to a first threshold value, a second condition in which the first UL ReTX indicator in each of the consecutive time intervals (e.g., the time intervals t_{d}, tₑ, and t_{f} 940, 950, and 960 of FIG. 9) is less than a second threshold value, a third condition in which the downlink retransmission ratio in each of the consecutive time intervals (e.g., the time intervals tₐ, t_{b}, and t_{c} 1010, 1020, and 1030 of FIG. 10) is greater than or equal to a fifth threshold value, or a fourth condition in which the downlink retransmission ratio in each of the consecutive time intervals (e.g., the time intervals t_{d}, tₑ, and t_{f} 1040, 1050, and 1060 of FIG. 10) is less than a sixth threshold value.

According to an embodiment, the specified number in operation 1220 may be, for example, three (3), but is not limited thereto.

The electronic device may adjust the bit rate of the codec in operation 1230 when the predefined condition (e.g., the first condition, the second condition, the third condition, or the fourth condition) is satisfied (Yes at operation 1220). For example, the electronic device may adjust the bit rate of the codec from the bit rate #1 (e.g., the bit rate #1 of FIG. 9) to the bit rate #2 (e.g., the bit rate #2 of FIG. 9) when the first condition is satisfied. The electronic device may adjust the bit rate of the codec from the bit rate #2 (e.g., the bit rate #2 of FIG. 9) to the bit rate #1 (e.g., the bit rate #1 of FIG. 9) when the second condition is satisfied. The electronic device may adjust the bit rate of the codec from the bit rate #1 (e.g., the bit rate #1 of FIG. 10) to the bit rate #2 (e.g., the bit rate #2 of FIG. 10) when the third condition is satisfied. The electronic device may adjust the bit rate of the codec from the bit rate #2 (e.g., the bit rate #2 of FIG. 10) to the bit rate #1 (e.g., the bit rate #1 of FIG. 10) when the fourth condition is satisfied.

In operation 1240, the electronic device may maintain the bit rate of the codec when the predefined condition is not satisfied (No at operation 1220).

The embodiments described with reference to FIGS. 1, 2, 3A, 3B, 4A, 4B, and 5 to 11 may be applied to the electronic device of FIG. 12.

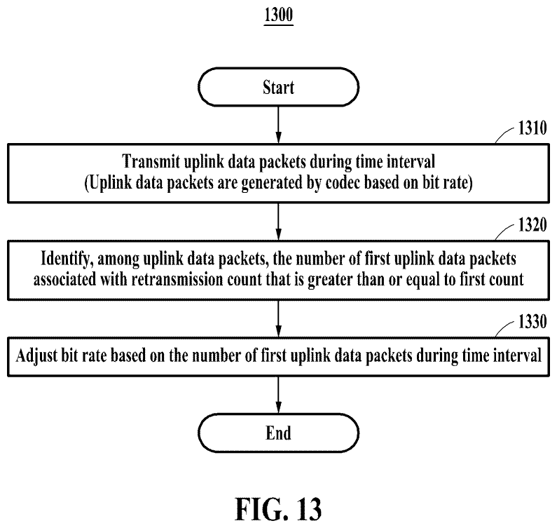

FIG. 13 is a flowchart illustrating an example of an operating method 1300 of an electronic device, according to an embodiment.

The operating method 1300 described with reference to FIG. 13 may be performed by an electronic device (e.g., the electronic device 101 of FIG. 1, the electronic device 201 of FIG. 2, the electronic device 301 of FIGS. 3A, 3B, 4A, 4B, and 5 to 10, and the electronic device 1101 of FIG. 11).

Referring to FIG. 13, in operation 1310, the electronic device may transmit uplink data packets (e.g., the pieces of uplink data 631-1 to 631-n of FIG. 6) to a network (e.g., the network 399 of FIGS. 3B and 4B) (or a base station) during a time interval (e.g., the first time interval 670 of FIG. 6). For example, the uplink data packets may be generated by a codec based on a bit rate. For example, the electronic device may perform encoding on voice data of a user based on a first bit rate by using the codec and may generate each of the uplink data packets through the encoding. The electronic device may transmit each of the uplink data packets to the network.

In operation 1320, the electronic device may identify, among the uplink data packets, the number of first uplink data packets associated with a retransmission count (e.g., an uplink retransmission count) that is greater than or equal to a first count. Each of the first uplink data packets may correspond to, for example, among the uplink data packets during the time interval, an uplink data packet of which a retransmission count (e.g., an uplink retransmission count) is greater than or equal to the first count.

In operation 1330, the electronic device may adjust the bit rate (e.g., the bit rate of the codec) based on the number of first uplink data packets during the time interval. Based on the number of first uplink data packets during the time interval, the electronic device may adjust the bit rate of the codec from a first bit rate to a second bit rate. For example, when the number of first uplink data packets during the time interval (e.g., the first time interval 670 of FIG. 6) is greater than or equal to a first number (or a first count threshold), the second bit rate (e.g., the bit rate #2) may be lower than the first bit rate (e.g., the bit rate #1). As another example, when the number of first uplink data packets during the time interval (e.g., the first time interval 670 of FIG. 6) is less than a second number (or a second count threshold), the second bit rate (e.g., bit rate #4 that is higher than the bit rate #1) may be higher than the first bit rate (e.g., the bit rate #1). The first number and the second number may be the same, but are not limited thereto, and the first number and the second number may be different.

In an embodiment, the first count may be less than the maximum count received from the base station.

According to an embodiment, the first count may correspond to (or be equal to) the maximum count (e.g., maxHARQ-Tx) received from the base station. In such a case, the electronic device may identify whether a retransmission count of any one of the uplink data packets during the time interval reaches the maximum count. The electronic device may adjust the bit rate to a lower bit rate than the first bit rate when the retransmission count of any one of the uplink data packets during the time interval reaches the maximum count. For example, the bit rate of the codec may be adjusted from the first bit rate (e.g., the bit rate #1) to a lower bit rate (e.g., the bit rate #2) than the first bit rate.

According to an embodiment, the electronic device may determine an indicator regarding uplink retransmission in the time interval (e.g., the first time interval 670 of FIG. 6) through the first uplink data packets. The electronic device may determine whether an adjustment of the bit rate (e.g., the first bit rate) is necessary based on the determined indicator. The electronic device may adjust the bit rate (e.g., the first bit rate) when the electronic device determines that the adjustment of the bit rate (e.g., the first bit rate) is necessary.

For example, the electronic device may calculate a first ratio between the number of uplink data packets during the time interval (e.g., the first time interval 670 of FIG. 6) and the number of first uplink data packets during the time interval (e.g., the first time interval 670 of FIG. 6). The electronic device may determine whether each of the first ratio and a ratio between the number of second uplink data packets during a previous time interval (e.g., at least one of the second time interval 660 and the third time interval 650 of FIG. 6) of the time interval and the number of uplink data packets during the previous time interval is greater than or equal to a first threshold value. Here, the second uplink data packets may be associated with the retransmission count that is greater than or equal to the first count among the uplink data packets during the previous time interval. Each of the second uplink data packets may correspond to an uplink data packet of which the retransmission count is greater than or equal to the first count among the uplink data packets during the previous time interval.

The electronic device may adjust the bit rate to a lower bit rate than the first bit rate when each of the first ratio and the ratio between the number of second uplink data packets during the previous time interval and the number of uplink data packets during the previous time interval is greater than or equal to the first threshold value. For example, the bit rate of the codec may be adjusted from the first bit rate (e.g., the bit rate #1) to a lower bit rate (e.g., the bit rate #2) than the first bit rate.

The electronic device may determine whether each of the first ratio and the ratio between the number of second uplink data packets during the previous time interval and the number of uplink data packets during the previous time interval is less than a second threshold value. The electronic device may adjust the bit rate to a higher bit rate than the first bit rate when each of the first ratio and the ratio between the number of second uplink data packets during the previous time interval and the number of uplink data packets during the previous time interval is less than the second threshold value. For example, the bit rate of the codec may be adjusted from the first bit rate (e.g., the bit rate #1) to a higher bit rate (e.g., the bit rate #4 that is higher than bit rate #1) rate than the first bit rate.

As another example, the electronic device may calculate a second ratio between the number of uplink data packets of which a retransmission count (e.g., an uplink retransmission count) reaches the maximum count among the uplink data packets during the time interval (e.g., the first time interval 670 of FIG. 6) and the number of uplink data packets during the time interval. The electronic device may determine whether the second ratio is greater than or equal to a third threshold value or less than or equal to a fourth threshold value. The electronic device may adjust the bit rate to a lower bit rate than the first bit rate when the second ratio is greater than or equal to the third threshold value. For example, the bit rate of the codec may be adjusted from the first bit rate (e.g., the bit rate #1) to a lower bit rate (e.g., the bit rate #2) than the first bit rate. The electronic device may adjust the bit rate to a higher bit rate than the first bit rate when the second ratio is less than or equal to the fourth threshold value. For example, the bit rate of the codec may be adjusted from the first bit rate (e.g., the bit rate #1) to a higher bit rate (e.g., the bit rate #4 that is higher than bit rate #1) than the first bit rate.

The embodiments described with reference to FIGS. 1, 2, 3A, 3B, 4A, 4B, and 5 to 12 may be applied to the electronic device of FIG. 13.

According to an embodiment, an electronic device (101, 201, 301, 1101) may include at least one processor (120, 210, 1120) including processing circuitry and memory (130, 1110) storing instructions. The instructions, when executed by the at least one processor individually or collectively, may cause the electronic device to transmit uplink data packets during a time interval, in which the uplink data packets are encoded by a codec based on a first bit rate, identify the number of first uplink data packets among the uplink data packets, which is associated with a retransmission count that is greater than or equal to a first count (or a first retransmission threshold), and adjust a bit rate of the codec from the first bit rate to a second bit rate based on the number of the first uplink data packets during the time interval.

The second bit rate may be lower than the first bit rate when the number of the first uplink data packets during the time interval is greater than or equal to a first number. The first number may be alternatively expressed as a first count threshold.

The second bit rate may be higher than the first bit rate when the number of the first uplink data packets during the time interval is less than a second number. The second number may be alternatively expressed as a second count threshold.

The first count may be determined by the electronic device.

The first count may correspond to the maximum count (or a maximum retransmission threshold) received from a base station.

The identifying of the number of the first uplink data packets among the uplink data packets may include identifying whether a retransmission count of one of the uplink data packets reaches the maximum count. The adjusting of the bit rate of the codec from the first bit rate to the second bit rate may include adjusting the bit rate of the codec to a lower bit rate than the first bit rate when the retransmission count of one of the uplink data packets reaches the maximum count.

The adjusting of the bit rate of the codec from the first bit rate to the second bit rate may include determining an indicator regarding uplink retransmission (or an uplink retransmission indicator) in the time interval through the first uplink data packets, determining whether an adjustment of the first bit rate is necessary based on the determined indicator (e.g., the determined uplink retransmission indicator), and adjusting the first bit rate when it is determined that the adjustment of the first bit rate is necessary.

The determining of the indicator (e.g., the uplink retransmission indicator) may include calculating a first ratio between the number of the uplink data packets during the time interval and the number of the first uplink data packets during the time interval.

The determining of whether the adjustment of the first bit rate is necessary may include determining whether each of the calculated first ratio and a ratio between the number of second uplink data packets during a previous time interval of the time interval and the number of uplink data packets during the previous time interval is greater than or equal to a first threshold value, in which the second uplink data packets are associated with the retransmission count that is greater than or equal to the first count among the uplink data packets during the previous time interval, or determining whether each of the calculated first ratio and the ratio is less than a second threshold value.

The adjusting of the first bit rate may include adjusting the bit rate of the codec to a lower bit rate than the first bit rate when each of the calculated first ratio and the ratio is greater than or equal to the first threshold value or adjusting the bit rate of the codec to a higher bit rate than the first bit rate when each of the calculated first ratio and the ratio is less than the second threshold value.

The determining of the indicator (e.g., the uplink retransmission indicator) may include calculating a second ratio between the number of the uplink data packets of which the retransmission count reaches the maximum count and the number of uplink data packets during the time interval. The determining of whether the adjustment of the first bit rate is necessary may include determining whether the calculated second ratio is greater than or equal to a third threshold value or less than or equal to a fourth threshold value.

The adjusting of the first bit rate may include adjusting the bit rate of the codec to a lower bit rate than the first bit rate when the calculated second ratio is greater than or equal to the third threshold value or adjusting the bit rate of the codec to a higher bit rate than the first bit rate when the calculated second ratio is less than or equal to the fourth threshold value.

The instructions, when executed by the at least one processor individually or collectively, may cause the electronic device to identify first downlink data packets retransmitted from among downlink data packets that are received during the time interval, determine an indicator regarding downlink retransmission (or a downlink retransmission indicator) in the time interval through the first downlink data packets, and determine whether an adjustment of the first bit rate is necessary based on the indicator regarding the downlink retransmission (e.g., the determined downlink retransmission indicator).

The determining of the indicator (e.g., the downlink retransmission indicator) may include calculating a third ratio between the number of the received downlink data packets and the number of the first downlink data packets. The determining of whether the adjustment of the first bit rate is necessary may include determining whether each of the calculated third ratio and a ratio between the number of second downlink data packets retransmitted from among downlink data packets during a previous time interval of the time interval and the number of the downlink data packets during the previous time interval is greater than or equal to a fifth threshold value, determining whether each of the calculated third ratio and the ratio is less than a sixth threshold value, or determining whether the calculated third ratio is less than or equal to a seventh threshold value.

The adjusting of the bit rate of the codec from the first bit rate to the second bit rate may include adjusting the bit rate of the codec to a lower bit rate than the first bit rate when each of the calculated third ratio and the ratio is greater than or equal to the fifth threshold value, adjusting the bit rate of the codec to a higher bit rate than the first bit rate when each of the calculated third ratio and the ratio is less than the sixth threshold value, or adjusting the bit rate of the codec to a higher bit rate than the first bit rate when the calculated third ratio is less than or equal to the seventh threshold value.

According to an embodiment, an electronic device (101, 201, 301, 1101) may include at least one processor (120, 210, 1120) including processing circuitry and memory (130, 1110) storing instructions. The instructions, when executed by the at least one processor individually or collectively, may cause the electronic device to transmit uplink data packets during a time interval, identify first uplink data packets among the uplink data packets, which are associated with a retransmission count that is greater than or equal to a first count, determine an indicator regarding uplink retransmission in the time interval through the first uplink data packets, determine whether an adjustment of a bit rate of a codec is necessary based on the indicator, and adjust the bit rate when it is determined that the adjustment of the bit rate is necessary.

The determining of the indicator may include calculating a first ratio between the number of the uplink data packets during the time interval and the number of the first uplink data packets during the time interval. The determining of whether the adjustment of the bit rate is necessary may include determining whether each of the calculated first ratio and a ratio between the number of second uplink data packets during a previous time interval of the time interval and the number of uplink data packets during the previous time interval is greater than or equal to a first threshold value or determining whether each of the calculated first ratio and the ratio is less than a second threshold value. The second uplink data packets may be associated with the retransmission count that is greater than or equal to the first count among uplink data packets transmitted during the previous time interval.

The adjusting of the bit rate may include adjusting the bit rate to be low when each of the calculated first ratio and the ratio is greater than or equal to the first threshold value or adjusting the bit rate to be high when each of the calculated first ratio and the ratio is less than the second threshold value.

The determining of the indicator may include calculating a second ratio between the number of the uplink data packets of which the retransmission count reaches the maximum count and the number of the uplink data packets during the time interval. the determining of whether the adjustment of the bit rate is necessary may include determining whether the calculated second ratio is greater than or equal to a third threshold value or less than or equal to a fourth threshold value.

The adjusting of the bit rate may include adjusting the bit rate to be low when the calculated second ratio is greater than or equal to the third threshold value or adjusting the bit rate to be high when the calculated second ratio is less than or equal to the fourth threshold value.

According to an embodiment, an operating method of an electronic device (101, 201, 301, 1101) may include transmitting uplink data packets during a time interval, in which the uplink data packets are generated by a codec based on a bit rate, identifying the number of first uplink data packets among the uplink data packets, which is associated with a retransmission count that is greater than or equal to a first count, and adjusting the bit rate based on the number of the first uplink data packets during the time interval.

According to an embodiment, a non-transitory computer-readable storage medium may include instructions. The instructions, when executed by at least one processor of an electronic device (101, 201, 301, 1101) individually or collectively, may cause the electronic device to transmit uplink data packets during a time interval, in which the uplink data packets are generated by a codec based on a bit rate, identify the number of first uplink data packets among the uplink data packets, which is associated with a retransmission count that is greater than or equal to a first count, and adjust the bit rate based on the number of the first uplink data packets during the time interval.

According to an embodiment, a non-transitory computer-readable storage medium may include instructions. The instructions, when executed by at least one processor of an electronic device (101, 201, 301, 1101) individually or collectively, may cause the electronic device to transmit uplink data packets during a time interval, identify first uplink data packets among the uplink data packets, which is associated with a retransmission count that is greater than or equal to a first count, determine an indicator regarding uplink retransmission in the time interval through the first uplink data packets, determine whether an adjustment of a bit rate of a codec is necessary based on the indicator, and adjust the bit rate when it is determined that the adjustment of the bit rate is necessary.

While this invention has been described with reference to illustrative embodiments, this description is not intended to be construed in a limiting sense. Various modifications and combinations of the illustrative embodiments, as well as other embodiments of the invention, may be apparent to persons skilled in the art upon reference to the description. It is therefore intended that the appended claims encompass any such modifications or embodiments.

What is claimed is:

1. An electronic device, comprising:
one or more processors comprising processing circuitry; and
memory storing instructions,
wherein the instructions, when executed by the one or more processors individually or collectively, cause the electronic device to:
transmit, during a first time interval, a plurality of first uplink data packets encoded by a codec based on a first bit rate;
identify a number of first retransmitted uplink data packets, from among the plurality of first uplink data packets, having a first retransmission count greater than or equal to a first retransmission threshold, and
adjust a bit rate of the codec from the first bit rate to a second bit rate based on the number of first retransmitted uplink data packets.

2. The electronic device of claim 1, wherein the adjusting of the bit rate comprises adjusting, based on the number of first retransmitted uplink data packets being greater than or equal to a first count threshold, the bit rate of the codec from the first bit rate to the second bit rate, the second bit rate being lower than the first bit rate.

3. The electronic device of claim 1, wherein the adjusting of the bit rate comprises adjusting, based on the number of first retransmitted uplink data packets being less than a second count threshold, the bit rate of the codec from the first bit rate to the second bit rate, the second bit rate being greater than the first bit rate.

4. The electronic device of claim 1, wherein the instructions, when executed by the one or more processors individually or collectively, further cause the electronic device to:
determine the first retransmission threshold.

5. The electronic device of claim 1, wherein the instructions, when executed by the one or more processors individually or collectively, further cause the electronic device to:
receive, from a base station, a maximum retransmission threshold, and
wherein the first retransmission threshold corresponds to the maximum retransmission threshold.

6. The electronic device of claim 5, wherein the identifying of the number of the first retransmitted uplink data packets comprises identifying whether a second retransmission count of at least one uplink data packet of the plurality of first uplink data packets reaches the maximum retransmission threshold; and
wherein the adjusting of the bit rate comprises adjusting the bit rate of the codec from the first bit rate to a lower bit rate than the first bit rate based on the second retransmission count of the at least one uplink data packet reaching the maximum retransmission threshold.

7. The electronic device of claim 1, wherein the instructions, when executed by the one or more processors individually or collectively, further cause the electronic device to:
determine an uplink retransmission indicator based on retransmission counts of the first retransmitted uplink data packets;
determine whether to adjust the bit rate of the codec based on the uplink retransmission indicator; and
adjust the first bit rate based on a determination to adjust the bit rate of the codec.

8. The electronic device of claim 7, wherein the determining of the uplink retransmission indicator comprises calculating a first ratio between a number of the plurality of first uplink data packets and the number of first retransmitted uplink data packets, and
wherein the determining whether to adjust the bit rate comprises:
determining whether each of the calculated first ratio and a ratio between a number of second uplink data packets during a previous time interval of the first time interval and a number of second retransmitted uplink data packets during the previous time interval is greater than or equal to a first threshold value, wherein the second retransmitted uplink data packets are associated with a second retransmission count that is greater than or equal to the first retransmission threshold among the second uplink data packets, or
determining whether each of the calculated first ratio and the ratio is less than a second threshold value.

9. The electronic device of claim 8, wherein the adjusting of the first bit rate comprises:
adjusting the bit rate of the codec from the first bit rate to a third bit rate based on the calculated first ratio and the ratio being greater than or equal to the first threshold value, the third bit rate being less than the first bit rate; and
adjusting the bit rate of the codec from the first bit rate to a fourth bit rate based on the calculated first ratio and the ratio being less than the second threshold value, the fourth bit rate being greater than the first bit rate.

10. The electronic device of claim 7, wherein the determining of the uplink retransmission indicator comprises calculating a second ratio between a number of uplink data packets having a retransmission count that reaches a maximum retransmission threshold and a number of the plurality of first uplink data packets; and
wherein the determining whether to adjust the bit rate comprises determine whether to adjust the bit rate of the codec based on the second ratio.

11. The electronic device of claim 10, wherein the adjusting of the first bit rate comprises:
adjusting the bit rate of the codec from the first bit rate to a lower bit rate than the first bit rate based on the second ratio being greater than or equal to a third threshold value; and
adjusting the bit rate of the codec from the first bit rate to a greater bit rate than the first bit rate based on the second ratio being less than or equal to a fourth threshold value.

12. The electronic device of claim 1, wherein the instructions, when executed by the one or more processors individually or collectively, further cause the electronic device to:
receive, during the first time interval, a plurality of first downlink data packets;
identify, from among the plurality of first downlink data packets, first retransmitted downlink data packets that have been retransmitted during the first time interval;
determine a downlink retransmission indicator based on retransmission counts of the first retransmitted downlink data packets; and
determine whether to adjust the bit rate of the codec based on the downlink retransmission indicator.

13. The electronic device of claim 12, wherein the determining of the downlink retransmission indicator comprises calculating a third ratio between a number of the first downlink data packets and a number of the first retransmitted downlink data packets, and
wherein the determining whether to adjust the bit rate comprises:
determining whether each of the calculated third ratio and a ratio between a number of second retransmitted downlink data packets retransmitted from among downlink data packets during a previous time interval of the first time interval and a number of the downlink data packets during the previous time interval is greater than or equal to a fifth threshold value,
determining whether each of the calculated third ratio and the ratio is less than a sixth threshold value, or
determining whether the calculated third ratio is less than or equal to a seventh threshold value.

14. The electronic device of claim 13, wherein the adjusting of the first bit rate comprises:
adjusting the bit rate of the codec from the first bit rate to a lower bit rate than the first bit rate based on the ratio and the calculated third ratio being greater than or equal to the fifth threshold value;
adjusting the bit rate of the codec from the first bit rate to a greater bit rate than the first bit rate based on the ratio and the calculated third ratio being less than the sixth threshold value; and
adjusting the bit rate of the codec from the first bit rate to a greater bit rate than the first bit rate based on the calculated third ratio being less than or equal to the seventh threshold value.

15. An electronic device, comprising:
one or more processors comprising processing circuitry; and
memory storing instructions,
wherein the instructions, when executed by the one or more processors individually or collectively, cause the electronic device to:
transmit, during a first time interval, a plurality of first uplink data packets;
identify, from among the plurality of first uplink data packets, first retransmitted uplink data packets having a first retransmission count greater than or equal to a first retransmission threshold;
determine an uplink retransmission indicator based on retransmission counts of the first retransmitted uplink data packets;
determine whether to adjust a bit rate of a codec based on the retransmission indicator; and
adjust the bit rate of the codec based on a determination to adjust the bit rate of the codec.

16. The electronic device of claim 15, wherein the determining of the uplink retransmission indicator comprises calculating a first ratio between a number of the first uplink data packets and a number of the first retransmitted uplink data packets, and
wherein the determining whether to adjust the bit rate comprises:
determining whether each of the calculated first ratio and a ratio between a number of second uplink data packets during a previous time interval of the first time interval and a number of second retransmitted uplink data packets during the previous time interval is greater than or equal to a first threshold value, wherein the second retransmitted uplink data packets are associated with a second retransmission count that is greater than or equal to the first retransmission threshold among the second uplink data packets, or
determining whether each of the calculated first ratio and the ratio is less than a second threshold value.

17. The electronic device of claim 16, wherein the adjusting of the bit rate comprises:
lowering the bit rate of the codec based on the calculated first ratio and the ratio being greater than or equal to the first threshold value; and
increasing the bit rate of the codec based on the calculated first ratio and the ratio being less than the second threshold value.

18. The electronic device of claim 15, wherein the determining of the uplink retransmission indicator comprises calculating a second ratio between a number of uplink data packets of which retransmission count reaches a maximum retransmission threshold and a number of the first uplink data packets, and
wherein the determining whether to adjust the bit rate comprises determining whether the calculated second ratio is greater than or equal to a third threshold value or less than or equal to a fourth threshold value.

19. The electronic device of claim 18, wherein the adjusting of the bit rate comprises:
lowering the bit rate of the codec based on the second ratio being greater than or equal to the third threshold value; and
increasing the bit rate of the codec based the second ratio being less than or equal to the fourth threshold value.

20. An operating method of an electronic device, the operating method comprising:
transmitting, during a time interval, a plurality of uplink data packets, the plurality of uplink data packets being generated by a codec based on a first bit rate;
identifying a number of retransmitted uplink data packets, from among the plurality of uplink data packets, having a retransmission count greater than or equal to a retransmission threshold; and
adjusting a bit rate of the codec from the first bit rate to a second bit rate based on the number of the retransmitted uplink data packets.
